(19) United States
(12) Patent Application Publication
(10) Pub. No.: US 2013/0131294 A1
(43) Pub. Date: May 23, 2013

(54) Amidinate Catalyst Compounds, Process for Their Use and Polymers Produced Therefrom

(71) Applicants: John R. Hagadorn, Houston, TX (US); Ian C. Stewart, Houston, TX (US); Matthew S. Bedoya, Humble, TX (US)

(72) Inventors: John R. Hagadorn, Houston, TX (US); Ian C. Stewart, Houston, TX (US); Matthew S. Bedoya, Humble, TX (US)

(21) Appl. No.: 13/301,092

(22) Filed: Nov. 21, 2011

(51) Int. Cl. C08F 4/76; C08F 10/06; C08F 210/02; C08F 10/14; C07F 7/00; C08F 10/02; C08F 10/08

(52) U.S. Cl. 526/170; 556/52

(57) ABSTRACT

This invention relates to a method to polymerize olefins comprising contacting olefins with an amidinate catalyst compound, a chain transfer agent and an activator, where the amidinate catalyst compound is represented by the formula: (amindinate)ₓM(A)_{y}(L)_{z}, wherein M is a Group 4 metal; each L is, independently, a Lewis base, provided that each L is not a cyclopentadienyl group; each A is, independently, any anionic ligand, provided that each A is not a cyclopentadienyl group; x is 1, 2, or 3; y is 0, 1, 2, or 3; z is 0, 1, 2, or 3; and wherein x+y is equal to the coordination number of M, preferably 3 or 4.

### FIELD OF THE INVENTION

This invention relates to amidinate catalyst compositions and their use in olefin polymerization processes to produce ethylene polymers.

### BACKGROUND OF THE INVENTION

The insertion of ethylene into Al—C bonds, or the addition of aluminum alkyls to ethylene (carboalumination), is an industrial process of great importance. Long-chain aluminum alkyls can easily be transformed to the corresponding alcohols via oxidation with oxygen. Such alcohols have wide applications in areas such as personal care and polymer/leather/metal processing as well as agriculture; and are used in cosmetics, flavors, fragrances, plastics (as plasticizers), paints, coatings, industrial cleaning materials, etc. Further applications would be possible if these long chain alcohols (or even longer ones) were efficiently accessible in commercially viable systems.

Ethylene polymerizations using triethylaluminum, N,N,N-trialkyl ammonium tetrakis(pentafluorophenyl) borate and aminopyridinato ligand stabilized hafnium pentamethylcyclopentadienyl complexes, using the following aminopyridinato ligands: N-(2,6-diisopropylphenyl)-pyridine-2-amine, N-(2,6-diisopropylphenyl)-6-methylpyridine-2-amine), 6-bromo-N-(2,6-diisopropylphenyl)pyridine-2-amine, 6-chloro-N-(2,6-diisopropylphenyl)pyridine-2-amine, and N-mesityl-4-methylpyridine-2-amine are disclosed in “Synthesis of Alumina-Terminated Linear PE with a Hafnium Aminopyridinate Catalyst,” Isabelle Haas, Winfried P. Kretschmer, and Rhett Kempe, Organometallaics, 2011, 30 (18) pp 4854-4861.

Likewise, ethylene/propylene polymerizations using: 1) diethylzinc; 2) triethylaluminum, tri-isobutylaluminum, or tri-n-propuyl aluminum; and 3) [(C₅Me₅)Hf(Me)[N(Et)C(Me)N(Et)]][B(C₆F₅)₄] are disclosed in Angew. Chem. Int. Ed. 2010, 49, pp 1768-1772.

Zhang, W. and Sita, L. R., J. Am. Chem. Soc. 2008, 130, pp 442-443 discloses a catalyst system that uses “living coordinative chain-transfer polymerization” to produce very narrow molecular weight distribution atactic PP, e.g., a catalyst system featuring an anionic cyclopentadienyl (or substituted cyclopentadienyl) donor ligand.

WO 2009/061499 A1 discloses a process for the preparation of polyolefins via living coordinative chain transfer polymerization using a catalyst system featuring an anionic cyclopentadienyl (or substituted cyclopentadienyl) donor ligands.

WO 2007/035485 A1 discloses catalytic “olefin diblock copolymers” produced using chain transfer in series reactors not using NN catalyst systems.

U.S. Pat. No. 6,262,198 discloses amidinato metal complexes in combination with an activator, but absent chain transfer agent, for the polymerization of olefins. In particular, Examples 1-3 disclose the combination of bis[N,N′-bis(trimethylsilyl)benzamidinato metal dichloride (where the metal is Zr or Ti) with methylalumoxane at ratios of from 1000:1 to 5000:1 to produce polyethylene having an Mw/Mn of from 27 to 98.

WO 2005/092935 discloses magnesium adducts in combination with amidinates, but absent activator and chain transfer agent. For example, Run Number 3 on Table 2 produced a polyethylene having an Mw of 602,000 and an Mw/Mn of 2.3.

Group 4 bisamido catalysts are disclosed in U.S. Pat. No. 5,318,935. Bidentate bisarylamido catalysts are disclosed by D. H. McConville, et al, Macromolecules 1996, 29, pp 5241-5243.

U.S. Pat. No. 6,891,006 discloses yttrium based catalyst complexes used to polymerize ethylene that obtains low Mw/Mns.

U.S. Pat. No. 5,502,128 discloses polymerization of ethylene with methylalumoxane and (N,N′-dimethyl-p-toluamidinate)titanium (IV) trichloride dimer or N,N′-bis(trimethylsilyl)benzamidinate titanium (IV) triisopropoxide, but absent chain transfer agent.

The present inventors have found that group 4 transition metal (such as zirconium) amidinate catalysts undergo rapid and reversible chain transfer to aluminum (such as tri-n-octylaluminum). The result is an end-metallated, narrow Mw/Mn polyolefin product. The reversibility of these chain transfer processes can also be modulated by addition of a chain transfer agent, resulting in production of bi- or multi-modal molecular weight distribution polymers.

### SUMMARY OF THE INVENTION

This invention relates to a method to polymerize olefins comprising:

1) contacting, at the transition temperature or higher, olefins with an amidinate catalyst compound, a chain transfer agent, and a non-coordinating anion activator, where the molar ratio of the chain transfer agent(s) to amidinate catalyst compound(s) is 5:1 or more, and where the amidinate catalyst compound is represented by the formula:

(amindinate)ₓM(A)_{y}(L)_{z}

where M is a Group 4 metal; each L is, independently, a Lewis base, provided that each L is not a cyclopentadienyl group; each A is, independently, any anionic ligand, provided that each A is not a cyclopentadienyl group; x is 1, 2, or 3; y is 0, 1, 2, or 3; z is 0, 1, 2, or 3; where x+y is equal to the coordination number of M, preferably 3 or 4; and
2) obtaining polymer having an Mw (determined by GPC-DRI) of 500,000 g/mol or less, Mw/Mn of 1.5 or less, and an Mn (determined by GPC-DRI) of from A′ g/mol to Z g/mol, where A′ is (1/q×(yield of polyolefin in grams/mols of chain transfer agent(s)+mols of transition metal catalyst compound(s)); and Z is (1/m x (yield of polyolefin in grams/mols of chain transfer agent compound(s)+mols of transition metal catalyst compound(s)), where q is 0.5 and m is 4.

This invention also relates to a method to polymerize olefins comprising contacting, at the transition temperature or higher, olefins (such as C₂ to C₄₀ olefins) with an amidinate catalyst compound, a chain transfer agent, and a non-coordinating anion activator, where the molar ratio of the chain transfer agent(s) to amidinate catalyst compound(s) is 5:1 or more, and where the amidinate catalyst compound is preferably represented by the formula:

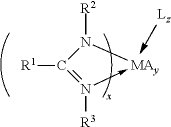

where M is a Group 4 metal;
R¹ is hydrogen, a hydrocarbyl group, a silylcarbyl group, a substituted silylcarbyl group, or a substituted hydrocarbyl group having 1 to 40 carbon atoms;
R² and R³ are each, independently, a hydrocarbyl group, a silylcarbyl group, a substituted silylcarbyl group, or a substituted hydrocarbyl group having 1 to 40 carbon atoms;
each L is, independently, a Lewis base, provided that each L is not a cyclopentadienyl group;
each A is, independently, any anionic ligand, provided that each L is not a cyclopentadienyl group;
x is 1, 2, or 3;
y is 0, 1, 2, or 3;
z is 0, 1, 2, or 3;
where x+y is equal to the coordination number of M, preferably 3 or 4; and
2) obtaining polymer having an Mw (determined by GPC-DRI) of 500,000 g/mol or less, Mw/Mn of 1.5 or less, and an Mn (determined by GPC-DRI) of from A′ g/mol to Z g/mol, where A′ is (1/q×(yield of polyolefin in grams/mols of chain transfer agent(s)+mols of transition metal catalyst compound(s)); and Z is (1/m×(yield of polyolefin in grams/mols of chain transfer agent compound(s)+mols of transition metal catalyst compound(s)), where q is 0.5 and m is 4.

This invention also relates to new amidinate catalyst compounds represented by the formula:

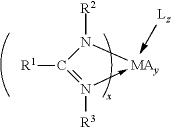

where M is a Group 4 metal;
R¹ is a substituted or unsubstituted tolyl or benzyl group having 7 to 40 carbon atoms, preferably a substituted tolyl, benzyl (such as naphthyl);
R² and R³ are each, independently, a hydrocarbyl group, a silylcarbyl group, a substituted silylcarbyl group, or a substituted hydrocarbyl group having 1 to 40 (preferably 3 to 40) carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3; and
where x+y is equal to the coordination number of M, preferably 3 or 4.

This invention also relates to a method to obtain a polymer having a multimodal (preferably bimodal) molecular weight distribution comprising contacting olefins (such as C₂ to C₄₀ olefins), at a temperature below the transition temperature, with an amidinate catalyst compound, at least one chain transfer agent, and a non-coordinating anion activator, where the molar ratio of the chain transfer agent(s) to amidinate catalyst compound(s) is 5:1 or more, and where the amidinate catalyst compound is preferably represented by the formula:

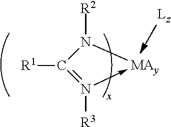

where M is a Group 4 metal;
R¹ is hydrogen, or a hydrocarbyl group, a silylcarbyl group, a substituted silylcarbyl group, or a substituted hydrocarbyl group having 1 to 40 carbon atoms;
R² and R³ are each, independently, a hydrocarbyl group, a silylcarbyl group, a substituted silylcarbyl group, or a substituted hydrocarbyl group having 1 to 40 (preferably 3 to 40) carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3;
where x+y is equal to the coordination number of M, preferably 3 or 4; and
2) obtaining polymer having a multimodal GPC trace.

This invention also relates to metallated polymers, preferably represented by the formula M¹R²⁰₃ or M²R²⁰₂, where R²⁰ is a polyolefin having an Mn of 50,000 g/mol or more, M¹ is a group 13 atom, and M² is a group 12 atom.

### BRIEF DESCRIPTION OF THE FIGURES

FIG. 1 is a plot of (nanograms of polymer/Mn of polymer) vs. nanomols of AlOct₃ using data from Runs 2-7 of Table 3.

FIG. 2 is an overlay of GPC traces showing the effect of increasing Oct₃Al on Catalyst 2/NCA1. The far left peak is Experiment 12, the middle peak is Experiment 1, and the tallest peak is Experiment 6 from Table 5.

FIG. 3 is an overlay of GPC traces showing the effect of increasing Oct₃Al on Catalyst 1/NCA1 in the presence of iPr₂Zn. The tallest peak (on the right) is Experiment 32, the next tallest peak (on the left) is Experiment 33, and the peak immediately below Experiment 33 is Experiment 34 from Table 5.

FIG. 4 is an overlay of Overlay of GPC traces showing the effect of increasing Oct₃Al on Catalyst 2/NCA1 in the presence of Et₂Zn. The tallest trace (on the right) is Experiment 3, the far left trace is Experiment 11, and the remaining trace is Experiment 8 from Table 5.

FIG. 5 is an overlay of GPC traces showing the effect of increasing Oct₃Al on Catalyst 1/NCA1. The tallest trace on the left is Experiment 10, the shortest trace on the left is Experiment 7, and the trace in the middle is Experiment 2 from Table 5.

FIG. 6 is an overlay of GPC traces showing the effect of increasing Oct₃Al on Catalyst 1/NCA1. The tallest trace on the left is Experiment 9, the shortest trace on the left is Experiment 5, and the trace in the middle is Experiment 4 from Table 5.

FIG. 7 is an overlay of GPC traces showing the effect of increasing Oct₃Al on catalyst 2/NCA2. The tallest peak (on the right) is Experiment 15, the next tallest peak (on the left) is Experiment 20, and the shorter peak in the middle is Experiment 18 from Table 5.

FIG. 8 is an overlay of GPC traces showing the effect of increasing Oct₃Al on Catalyst 2/NCA2 in the presence of Et₂Zn. The tallest peak is Experiment 15 and the shorter peak is Experiment 14 from Table 5.

FIG. 9 is an overlay of GPC traces showing the effect of increasing Oct₃Al on Catalyst 1/NCA2. The tallest peak (on the left) is Experiment 21, the second tallest peak (on the right) is Experiment 13, the third tallest peak (on the left) is Experiment 19, and the shortest peak on the left is Experiment 16 from Table 5.

FIG. 10 is an overlay of GPC traces showing the effect of increasing Oct₃Al on Catalyst 1/NCA2 in the presence of Et₂Zn. The tallest peak (on the left) is Experiment 21, the next tallest peak (on the right) is Experiment 14, and the nearly flat trace is Experiment 17 from Table 5.

FIG. 11 is an overlay of GPC traces showing the effect of increasing Oct₃Al on Catalyst 2/NCA1 in the presence of Et₂Zn. The tallest peak (on the right) is Experiment 22, the next tallest peak (on the right) is Experiment 23, and the shorter bimodal peak is Experiment 25 from Table 5.

FIG. 12 is an overlay of GPC traces showing the effect of increasing Oct₃Al on Catalyst 2/NCA1 in the presence of iPr₂Zn. In order from right to left, the traces are of Experiments 31, 30, and 29 from Table 5, respectively.

FIG. 13 is an overlay of GPC traces showing the effect of increasing Oct₃Al on Catalyst 1/NCA1 in the presence of Et₂Zn. The tallest peak (on the right) is Experiment 28, the next tallest peak (on the left) is Experiment 27, and the shorter peak underneath the tallest peak (on the right) is Experiment 26 from Table 5.

FIG. 14 is an overlay of GPC traces the effect of increasing Oct₃Al on 1/NCA1 in the presence of iPr₂Zn Experiments 32, 33, and 34 from Table 5. The tallest peak (on the right) is Experiment 32, the next tallest peak (on the right) is Experiment 34, and the shortest peak (on the right) is Experiment 33.

### DEFINITIONS

The term “polyolefin” as used herein means an oligomer or polymer of two or more olefin mer units and specifically includes oligomers and polymers as defined below. An “olefin,” alternatively referred to as “alkene,” is a linear, branched, or cyclic compound of carbon and hydrogen having at least one double bond. A “mono-olefin” has one double bond, either alpha or internal.

An ethylene polymer or oligomer contains at least 50 mol % of ethylene, a propylene polymer or oligomer contains at least 50 mol % of propylene, a butene polymer or oligomer contains at least 50 mol % of butene, and so on.

For purposes of this specification and the claims appended thereto, when a polymer or copolymer is referred to as comprising an olefin (such as ethylene), the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. The term “different” as used to refer to mer units indicates that the mer units differ from each other by at least one atom or are different isomerically. An oligomer is typically a polymer having a low molecular weight (such as Mn of less than 25,000 g/mol, preferably less than 2,500 g/mol) or a low number of mer units (such as 75 mer units or less, typically 50 mer units or less, even 20 mer units or less, even 10 mer units or less). The term “polymer” encompasses the terms “copolymer” and “terpolymer;” for example, the term “ethylene polymer” includes ethylene copolymers and ethylene terpolymers.

As used herein, Mn is number average molecular weight, Mw is weight average molecular weight, Mz is z average molecular weight, wt % is weight percent, and mol % is mole percent. Molecular weight distribution (MWD), also referred to as polydispersity, is defined to be Mw divided by Mn. Unless otherwise noted, all molecular weight units (e.g., Mw, Mn, Mz) are g/mol. The following abbreviations may be used herein: Me is methyl, Et is ethyl, Pr is propyl, nPr is n-propyl, iPr is isopropyl, Bu is butyl, nBu is normal butyl, iBu is isobutyl, Oct is octyl, Ph is phenyl, Bn is benzyl, THF or thf is tetrahydrofuran. MAO is methylalumoxane and is defined to have an Mw of 58.06 g/mol.

As used herein, the new notation for the Periodic Table Groups is used as described in Chemical and Engineering News, 63(5), 27 (1985). Room temperature is 23° C. unless otherwise noted.

The term “substituted” generally means that a hydrogen group has been replaced with a hydrocarbyl group, a heteroatom or a heteroatom containing group. For example, methyl cyclopentadiene is a cyclopentadiene (Cp) group substituted with a methyl group and ethyl alcohol is an ethyl group substituted with an —OH group.

The terms “hydrocarbyl radical,” “hydrocarbyl,” and “hydrocarbyl group” are used interchangeably throughout this document. Likewise, the terms “group” and “substituent” are also used interchangeably in this document. For purposes of this disclosure, “hydrocarbyl radical” is defined to be C₁ to C₄₀ radicals, that may be linear, branched, or cyclic (aromatic or non-aromatic); and include substituted hydrocarbyl radicals as defined below.

Substituted hydrocarbyl radicals are radicals in which at least one hydrogen atom has been substituted with a heteroatom or heteroatom containing group, preferably with at least one functional group such as halogen (Cl, Br, I, F), NR*₂, OR*, SeR*, TeR*, PR*₂, AsR*₂, SbR*₂, SR*, BR*₂, SiR*₃, GeR*₃, SnR*₃, PbR*₃, and the like or where at least one heteroatom has been inserted within the hydrocarbyl radical, such as halogen (Cl, Br, I, F), O, S, Se, Te, NR*, PR*, AsR*, SbR*, BR*, SiR*₂, GeR*₂, SnR*₂, PbR*₂, and the like, where R* is, independently, hydrogen or a hydrocarbyl.

A “substituted alkyl” or “substituted aryl” group is an alkyl or aryl radical made of carbon and hydrogen where at least one hydrogen is replaced by a heteroatom, a heteroatom containing group, or a linear, branched, or cyclic substituted or unsubstituted hydrocarbyl group having 1 to 30 carbon atoms.

A “substituted tolyl or benzyl” is a tolyl or benzyl, where at least one hydrogen has been replaced by a non hydrogen atom, for example, naphthyl is considered a substituted benzyl.

The terms “silylcarbyl radical,” “silylcarbyl,” and “silylcarbyl group” are used interchangeably throughout this document. For purposes of this disclosure, “silylcarbyl group” is defined to be a C₁ to C₄₀ hydrocarblyl group that may be linear, branched, or cyclic (aromatic or non-aromatic) substituted with at least one Si atom. A “substituted silylcarbyl” group is a silylcarbyl group where at least one hydrogen has been substituted with a non-hydrogen, non-carbon atom. A hydrocarbyl radical substituted with two or more Si atoms is considered a substituted silylcarbyl group.

A cyclopentadienyl group is defined to mean an unsubstituted cyclopentadienyl compound or a heteroatom or hydrocarbyl substituted cyclopentadienyl compound. For purposes of this definition substituted indenes, unsubstituted indenes, substituted fluorenes, and unsubstituted fluorenes are considered to be substituted cyclopentadienyl compounds.

By “multimodal molecular weight distribution” or “multimodal GPC trace” is meant that the gel permeation chromatography (GPC) trace has more than one peak or inflection point. An inflection point is that point where the second derivative of the curve changes in sign (e.g., from negative to positive or vice versa). By “bimodal molecular weight distribution” is meant the GPC trace has two peaks or inflection points, e.g., two peaks, one peak and one inflection point, or two inflection points. Unless otherwise stated, the GPC trace (absorbance vs. retention time) is obtained according to the Rapid GPC method described in the examples below.

The transition temperature is that temperature where the catalyst system (e.g., the amidinate catalyst compound(s), the activator(s), and the chain transfer agent(s)), first produces polymer having: 1) an Mw (determined by GPC) from A″ g/mol to Z′ g/mol, where A″ is (1/q×(yield of polyolefin in grams/mols of chain transfer agent+mols of transition metal catalyst compound)); and Z′ is (1/m×(yield of polyolefin in grams/mols of chain transfer agent+mols of transition metal catalyst compound)), where q is 0.5, and m is 4; and 2) an Mw/Mn of 2.0 or less, where the catalyst system is tested in the polymerization conditions of interest at temperatures varying from 50° C. to 140° C. at 5° C. intervals. For purposes of determining the transition temperature, a molar ratio of the chain transfer agent(s) to amidinate compound(s) of 25:1 is used. In preferred transition temperatures, q is 1 and m is 3.5, alternately q is 1.5 and m is 3.

### DETAILED DESCRIPTION

This invention relates to a method to polymerize olefins comprising contacting olefins (preferably C₂ to C₄₀ olefins, preferably C₂ to C₂₀ alpha olefins, preferably ethylene, propylene, butene, pentene, hexene, heptene, octene, nonene, decene, undecene, dodecene, and isomers thereof) with an amidinate catalyst compound, a chain transfer agent and a non-coordinating anion activator.

In a preferred embodiment, the amidinate complexes described herein (such as zirconium amidinate complexes of the general formula (amidinate)ₙZr(Bn)₄₋ₙ (n=1−2)), when activated with a non coordinating anion activator, were found to polymerize ethylene in the presence of trialkyl aluminum (such as AlOct₃) to yield polymers of narrow polydispersity. Additionally, it was observed that the molecular weight of the polymers decreases linearly with increasing trialkylaluminum (such as AlOct₃) concentration. This suggests a mechanism involving reversible or semi-reversible chain transfer of the growing polymer chain to aluminum. Thus, this provides a route to end-aluminated polyethylene which can be used to prepare other end-functionalized derivatives. Additionally, the herein described catalyst system can enable the production of diblock or multiblock copolymers when employed in either multiple reactors or as components of a mixed catalyst system wherein chain transfer occurs between the catalysts. Finally, in the presence of a chain-transfer catalyst (such as a dialkyl zinc, e.g., Et₂Zn) and temperatures below the transition temperature, bimodal molecular weight distributions are obtained, and can be modulated with increasing chain transfer agent (such as AlOct₃) concentration.

This invention relates to a method to polymerize olefins comprising:

1) contacting, at the transition temperature or higher (alternately at least 5° C. or more above the transition temperature, alternately at least 10° C. or more above the transition temperature, alternately at 90° C. or more, alternately 95° C. to 200° C., alternately 100° C. to 150° C.), olefins (preferably C₂ to C₄₀ olefins, preferably C₂ to C₂₀ alpha olefins, preferably olefins selected from the group consisting of ethylene, propylene, butene, pentene, hexene, heptene, octene, nonene, decene, undecene dodecene, and isomers thereof) with an amidinate catalyst compound, a chain transfer agent, and a non-coordinating anion activator, where the molar ratio of the chain transfer agent(s) to amidinate catalyst compound(s) is 5:1 or more, (alternately 10:1 or more, alternately 20:1 or more, alternately 25:1 or more, alternately 50:1 or more, alternately 100:1 or more), and where the amidinate catalyst compound is represented by the formula:

(amindinate)ₓM(A)_{y}(L)_{z}

where M is a Group 4 metal (preferably Hf or Zr); each L is, independently, a Lewis base, provided that each L is not a cyclopentadienyl group; each A is, independently, any anionic ligand, provided that each A is not a cyclopentadienyl group; x is 1, 2, or 3; y is 0, 1, 2, or 3; z is 0, 1, 2, or 3; where x+y is equal to the coordination number of M, preferably 3 or 4; and
2) obtaining polymer having an Mw (determined by GPC) of 500,000 g/mol or less (preferably 450,000 g/mol or less, preferably 400,000 g/mol or less), Mw/Mn of 1.5 or less (alternately 1.4 or less, alternately 1.3 or less), and an Mn (determined by GPC) of from A′ g/mol to Z g/mol, where A′ is (1/q×(yield of polyolefin in grams/mols of chain transfer agent+mols of transition metal catalyst compound)); and Z is (1/m×(yield of polyolefin in grams/mols of chain transfer agent+mols of transition metal catalyst compound)), where q is 0.5 and m is 4, alternately q is 1 and m is 3.5, alternately q is 1.5 and m is 3, alternately q is 2 and m is 3.

This invention also relates to a method to polymerize olefins comprising:

1) contacting, at the transition temperature or higher (alternately at least 5° C. or more above the transition temperature, alternately at least 10° C. or more above the transition temperature, alternately at 90° C. or more, alternately 95° C. to 200° C., alternately 100° C. to 150° C.), olefins (preferably C₂ to C₄₀ olefins, preferably C₂ to C₂₀ alpha olefins, preferably olefins selected from the group consisting of ethylene, propylene, butene, pentene, hexene, heptene, octene, nonene, decene, undecene, dodecene, and isomers thereof) with an amidinate catalyst compound, a chain transfer agent, and a non-coordinating anion activator, where the molar ratio of the chain transfer agent(s) to amidinate catalyst compound(s) is 5:1 or more, (alternately 10:1 or more, alternately 20:1 or more, alternately 25:1 or more, alternately 50:1 or more, alternately 100:1 or more), and where the amidinate catalyst compound is represented by the formula:

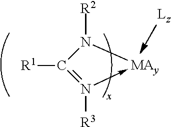

where M is a Group 4 metal, preferably Ti, Hf, or Zr;
R¹ is hydrogen, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms, preferably 1 to 20 carbon atoms;
R² and R³ are each, independently, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms, preferably 1 to 20 carbon atoms;
each L is, independently, a Lewis base, provided that each L is not a cyclopentadienyl group;
each A is, independently, any anionic ligand, provided that each L is not a cyclopentadienyl group;
x is 1, 2, or 3;
y is 0, 1, 2, or 3;
z is 0, 1, 2, or 3;
where x+y is equal to the coordination number of M, preferably 3 or 4; and
2) obtaining polymer having an Mw (determined by GPC-DRI) of 500,000 g/mol or less (preferably 450,000 g/mol or less, preferably 400,000 g/mol or less), Mw/Mn of 1.5 or less (alternately 1.4 or less, alternately 1.3 or less), and an Mn (determined by GPC-DRI) of from A′ g/mol to Z g/mol, where A′ is (1/q×(yield of polyolefin in grams/mols of chain transfer agent+mols of transition metal catalyst compound)); and Z is (1/m×(yield of polyolefin in grams/mols of chain transfer agent+mols of transition metal catalyst compound)), where q is 0.5 and m is 4, alternately q is 1 and m is 3.5, alternately q is 1.5 and m is 3, alternately q is 2 and m is 3.

This invention also relates to a method to obtain a polymer having a multimodal (preferably bimodal) molecular weight distribution comprising 1) contacting, at a temperature less than the transition temperature (alternately at least 5° C. below the transition temperature, alternately at least 10° C. below the transition temperature, alternately at less than 90° C., alternately at less than 85° C.), olefins (preferably C₂ to C₄₀ olefins, preferably C₂ to C₂₀ alpha olefins, preferably olefins selected from the group consisting of ethylene, propylene, butene, pentene, hexene, heptene, octene, nonene, decene, undecene, dodecene, and isomers thereof) with an amidinate catalyst compound, a chain transfer agent, and a non-coordinating anion activator, where the molar ratio of the chain transfer agent(s) to amidinate catalyst compound(s) is 5:1 or more, (alternately 10:1 or more, alternately 20:1 or more, alternately 25:1 or more, alternately 50:1 or more, alternately 100:1 or more), and where the amidinate catalyst compound is represented by the formula:

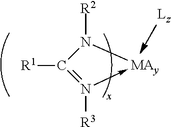

where M is a Group 4 metal, preferably Hf, Zr, or Ti;
R¹ is hydrogen, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms, preferably 1 to 20 carbon atoms;
R² and R³ are each, independently, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms, preferably 1 to 20 carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3;
where x+y is equal to the coordination number of M, preferably 3 or 4; and
2) obtaining polymer having a multimodal (preferably bimodal) GPC trace.

### Amidinate Catalyst Compounds

In a preferred embodiment, this invention relates to a process to polymerize olefins comprising contacting the olefins with one or more chain transfer agents, one or more activators and one or more amidinate catalyst compounds, preferably represented by the formula:

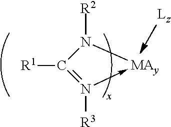

where M is a Group 4 metal, preferably Hf, Zr, and/or Ti, preferably Hf or Zr;
R¹ is a hydrogen, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms (preferably 1 to 20 carbon atoms), preferably an alkyl, substituted alkyl, aryl, or substituted aryl group having 1 to 40 (preferably 1 to 20 carbon atoms, preferably 2 to 12 carbon atoms), preferably R¹ is selected from the group consisting of methyl, ethyl, propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, toluoyl, chlorophenyl, phenol, substituted phenol, CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
R² and R³ are each, independently, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms (preferably 1 to 20 carbon atoms), preferably an alkyl, substituted alkyl, aryl, or substituted aryl group having 1 to 40 (preferably 1 to 20 carbon atoms, preferably 2 to 12 carbon atoms), preferably selected from the group consisting of methyl, ethyl, propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, toluoyl, chlorophenyl, phenol, substituted phenol, CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
each L is, independently, a neutral Lewis base, such as tetrahydrofuran, dialkyl ether (such as diethylether), dioxane, pyridine, pyrrole, tertiary amines, and the like, provided that each L is not a cyclopentadienyl group;
each A is, independently, any anionic ligand, preferably a hydrocarbyl radical, a halogen (preferably chlorine), a hydride, an amide, an alkoxide, a sulfide, an alkyl sulfonate, a phosphide, an amine, a phosphine, an ether, or a combination thereof or two A groups may be joined to form a dianionic group and may form a single ring of up to 30 non-hydrogen atoms or a multinuclear ring system of up to 30 non-hydrogen atoms, preferably each A is, independently, selected from the group consisting of hydrocarbyl radicals having from 1 to 20 carbon atoms, hydrides, amides, alkoxides, sulfides, phosphides, halides, amines, phosphines, ethers, and a combination thereof, (two A's may form a part of a fused ring or a ring system), preferably each A is independently selected from halides and C₁ to C₅ alkyl groups, preferably each A is a methyl group; provided that each A is not a cyclopentadienyl group (additional useful A groups are disclosed in U.S. Pat. No. 6,262,198 at column 2 line 62 to Column 3 line 19);
x is 1, 2, or 3, preferably 1 or 2
y is 0, 1, 2, or 3, preferably 2 or 3;
z is 0, 1, 2, or 3, preferably 0, 1, or 2, preferably 0 or 1, preferably 0; and
where x+y is equal to the oxidation number of M, preferably 3 or 4, preferably 4.

In an alternate embodiment, R¹, R², and R³ may be as described for the equivalent positions at column 3, lines 20-44 of U.S. Pat. No. 6,262,198.

Further, in some embodiments, when x is 2, the two aminate ligands may be linked to one another by the radicals R¹, R², and/or R³. Suitable bridge members are C₁-C₆-alkylene bridges or diorganosilyl bridges, for example dimethylsilyl, diethylsilyl or diphenylsilyl, or mixed C₁-C₆-alkylene/diorganosilyl bridges, for example, —CH₂—Si(CH₃)₂—CH₂— or —Si(CH₃)₂—CH₂—Si(CH₃)₂—.

In a preferred embodiment, the amidinate portion of the formula above (e.g., that within the parentheses) is derived from one or more of carbodiimides, 1,3-diisopropylcarbodiimide, 1-ethyl-3-tert-butylcarbodiimide, group 4 alkyls, Zr(CH₂Ph)₄, Zr(CH₂Ph)₂Cl₂(OEt₂)ₙ (n=0-2), Hf(CH₂Ph)₄, Hf(CH₂Ph)₂Cl₂(OEt₂)ₙ (n=0-2), Ti(CH₂Ph)₄.

In a preferred embodiment, M is Zr and each A is benzyl; Y is 4−x, and x is 1 or 2.

In a preferred embodiment, M is Zr and each A is methyl; Y is 4−x, and x is 1 or 2.

In a preferred embodiment, M is Hf and each A is methyl; Y is 4−x, and x is 1 or 2.

In a preferred embodiment, M is Hf and each A is benzyl; Y is 4−x, and x is 1 or 2.

In a preferred embodiment, M is Ti and each A is benzyl; Y is 4−x, and x is 1 or 2.

In a preferred embodiment, M is Ti and each A is chloride; Y is 4−x, and x is 1 or 2.

In a preferred embodiment, M is Ti and each A is methyl; Y is 4−x, and x is 1 or 2.

This invention also relates to new amidinate catalyst compounds represented by the formula:

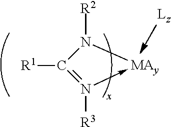

where M is a Group 4 metal;
R¹ is a substituted or unsubstituted tolyl or benzyl group having 7 to 40 carbon atoms (preferably 7 to 20 carbon atoms), preferably a substituted tolyl or benzyl, preferably R¹ is selected from the group consisting of mesityl, adamantyl, benzyl, tolyl, naphthyl, chlorophenyl, phenol, substituted phenol, CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
R² and R³ are each, independently, a hydrocarbyl group, a silylcarbyl group, a substituted silylcarbyl group, or a substituted hydrocarbyl group (preferably a hydrocarbyl group or substituted hydrocarbyl group) having 1 to 40 carbon atoms (preferably 3 to 40 carbon atoms, preferably 3 to 20 carbon atoms), preferably an alkyl, substituted alkyl, aryl, or substituted aryl group having 1 to 40 (preferably 1 to 20 carbon atoms, preferably 2 to 12 carbon atoms), preferably selected from the group consisting of methyl, ethyl, propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, toluoyl, chlorophenyl, phenol, substituted phenol, CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
each L is, independently, a neutral Lewis base, such as tetrahydrofuran, dialkyl ether (such as diethylether), dioxane, pyridine, pyrrole, tertiary amines, and the like; provided that each L is not a cyclopentadienyl group;
each A is, independently, any anionic ligand, preferably a hydrocarbyl radical, a halogen (preferably chlorine), a hydride, an amide, an alkoxide, a sulfide, an alkyl sulfonate, a phosphide, an amine, a phosphine, an ether or a combination thereof, or two A groups may be joined to form a dianionic group and may form a single ring of up to 30 non-hydrogen atoms or a multinuclear ring system of up to 30 non-hydrogen atoms, preferably each A is, independently, selected from the group consisting of hydrocarbyl radicals having from 1 to 20 carbon atoms, hydrides, amides, alkoxides, sulfides, phosphides, halides, amines, phosphines, ethers, and a combination thereof, (two A's may form a part of a fused ring or a ring system), preferably each A is independently selected from halides and C₁ to C₅ alkyl groups, preferably each A is a methyl group; provided that each A is not a cyclopentadienyl group (additional useful A groups are disclosed in U.S. Pat. No. 6,262,198 at column 2 line 62 to Column 3 line 19);
x is 1, 2, or 3, preferably 1 or 2;
y is 0, 1, 2, or 3, preferably 2 or 3;
z is 0, 1, 2, or 3, preferably 0, 1 or 2, preferably 0 or 1, preferably 0; and
where x+y is equal to the coordination number of M, preferably 3 or 4.

Preferably, the amidinate catalyst compound is one or more of: (N,N′-diisopropyl-o-toluamidinate)zirconium(IV) trimethyl, (N,N′-diisopropylbenzamidinate)zirconium(IV) trimethyl, bis(N,N′-diisopropylbenzamidinate)zirconium(IV) dimethyl, bis(N,N′-diisopropyl-phenylacetamidinate)zirconium(IV) dibenzyl, (N,N′-diisopropyl-o-toluamidinate)hafnium(IV) trimethyl, (N,N′-diisopropylbenzamidinate)hafnium(IV) trimethyl, bis(N,N′-diisopropylbenzamidinate)hafnium(IV) dimethyl, bis(N,N′-diisopropyl-phenylacetamidinate)hafnium(IV) dibenzyl, (N,N′-diisopropyl-o-toluamidinate)titanium(IV) trimethyl, (N,N′-diisopropylbenzamidinate)titanium(IV) trimethyl, bis(N,N′-diisopropylbenzamidinate)titanium(IV) dimethyl, bis(N,N′-diisopropyl-phenylacetamidinate)titanium(IV) dibenzyl.

Amidinate catalysts compounds can typically be prepared by reaction of 1 to 3 molar equivalents of carbodiimide with a transition metal reagent containing reactive metal carbon bonds. For example, the reaction of two equivalents of 1,3-diisopropylcarbodiimide with tetrabenzylzirconium affords bis[N,N′-diisopropylphenylacetamidinate]zirconium(IV) dibenzyl, which has the formula [PhCH₂(NⁱPr)₂]₂Zr(CH₂Ph)₂. A wide range of group 4 organometallics are suitable for this reaction, including those with mixed alkyl and halide groups (e.g., Hf(CH₂Ph)₂Cl₂(OEt₂), (n=0-2) and those containing other non-reactive anionic groups. The latter includes group 4 species (M=Ti, Zr, Hf) such as (cyclopentadienyl anion)M(alkyl)₃ or (substituted cyclopentadienyl anion)M(alkyl)₃, (alkoxide)M(alkyl)₃, (amido)M(alkyl)₃, and related species containing added Lewis bases.

### Chain Transfer Agents

For purposes of this invention and the claims thereto, the term chain transfer agent is defined to mean a compound that receives a polymeryl fragment from a catalyst compound, except that hydrogen is defined to not be a chain transfer agent for purposes of this invention. Chain transfer agents (CTA's) useful herein include triakyl aluminum compounds and dialkyl zinc compounds (where the alkyl is preferably a C₁ to C₄₀ alkyl group, preferably a C₂ to C₂₀ alkyl group, preferably a C₂ to C₁₂ alkyl group, preferably a C₂ to C₈ group, such as methyl, ethyl, propyl (including isopropyl and n-propyl), butyl (including n-butyl, sec-butyl, and iso-butyl) pentyl, hexyl, heptyl, octyl, and isomers an analogs thereof). Most preferred agents, for use in the present invention, are trialkyl aluminum compounds and dialkyl zinc compounds having from 1 to 8 carbons in each alkyl group, such as triethylaluminum (TEAL), tri(i-propyl)aluminum, tri(i-butyl)aluminum (TIBAL), tri(n-hexyl)aluminum, tri(n-octyl)aluminum (TNOAL), diethyl zinc, diisobutyl zinc, and dioctyl zinc.

The dialkyl zinc chain transfer agent is typically present in the reaction at a molar ratio of zinc to transition metal (from the amidinate catalyst compound) of 0.5:1 or more, preferably from 0.5:1 to 2000:1, preferably from 1:1 to 1000:1, preferably from 2:1 to 800:1, preferably from 3:1 to 700:1, preferably from 4:1 to 600:1.

In a preferred embodiment, one or more triakyl aluminum compounds and one or more dialkyl zinc compounds (where the alkyl is preferably a C₁ to C₄₀ alkyl group, preferably a C₂ to C₂₀ alkyl group, preferably a C₂ to C₁₂ alkyl group, preferably a C₂ to C₈ group, such as methyl, ethyl, propyl (including isopropyl and n-propyl), butyl (including n-butyl, sec-butyl and iso-butyl) pentyl, hexyl, heptyl, octyl, and isomers or analogs thereof) are used as the CTA. Preferred combinations include TEAL, TIBAL, and/or TNOAL with Et₂Zn, preferably TEAL and Et₂Zn, or TIBAL and Et₂Zn, or TNOAL and Et₂Zn. Preferably, the trialkyl aluminum and dialkyl zinc compounds are present in the reaction at a molar ratio of Al to Zn of 1:1 or more, preferably 2:1 or more, preferably 5:1 or more, preferably 10:1 or more, preferably 15:1 or more preferably from 1:1 to 10,000:1.

The combination of dialkyl zinc and trialkyl aluminum chain transfer agents is typically present in the reaction at a molar ratio of aluminum and zinc to transition metal (from the amidinate catalyst compound) of 5:1 or more, preferably from 10:1 to 2000:1, preferably from 20:1 to 1000:1, preferably from 25:1 to 800:1, preferably from 50:1 to 700:1, preferably from 100:1 to 600:1.

In other embodiments, suitable chain transfer agents for use herein include Group 1, 2, 12, or 13 metal compounds or complexes containing at least one C₁ to C₂₀ hydrocarbyl group, preferably hydrocarbyl substituted aluminum, gallium or zinc compounds containing from 1 to 12 carbons in each hydrocarbyl group, and reaction products thereof with a proton source. Preferred hydrocarbyl groups are alkyl groups, preferably linear or branched, C₂ to C₈ alkyl groups. The chain transfer agent is typically present in the reaction at a molar ratio of metal of the chain transfer agent to transition metal (from the amidinate catalyst compound) of 5:1 or more, preferably from 10:1 to 2000:1, preferably from 20:1 to 1000:1, preferably from 25:1 to 800:1, preferably from 50:1 to 700:1, preferably from 100:1 to 600:1.

Additional suitable chain transfer agents include the reaction product or mixture formed by combining the trialkyl aluminum or dialkyl zinc compound, preferably a tri(C₁-C₈)alkyl aluminum or di(C₁ to C₈)alkyl zinc compound, with less than a stoichiometric quantity (relative to the number of hydrocarbyl groups) of a secondary amine or a hydroxyl compound, especially bis(trimethylsilyl)amine, t-butyl(dimethyl)siloxane, 2-hydroxymethylpyridine, di(n-pentyl)amine, 2,6-di(t-butyl)phenol, ethyl(1-naphthyl)amine, bis(2,3,6,7-dibenzo-1-azacycloheptaneamine), or 2,6-diphenylphenol. Desirably, sufficient amine or hydroxyl reagent is used such that one hydrocarbyl group remains per metal atom. The primary reaction products of the foregoing combinations useful in the present invention as chain transfer agents include n-octylaluminum di(bis(trimethylsilyl)amide), i-propylaluminumbis(dimethyl(t-butyl)siloxide), and n-octylaluminum di(pyridinyl-2-methoxide), i-butylaluminum bis(dimethyl(t-butyl)siloxane), i-butylaluminum bis(di(trimethylsilyl)amide), n-octylaluminum di(pyridine-2-methoxide), i-butylaluminum bis(di(n-pentyl)amide), n-octylaluminum bis(2,6-di-t-butylphenoxide), n-octylaluminum di(ethyl(1-naphthyl)amide), ethylaluminum bis(t-butyldimethylsiloxide), ethylaluminum di(bis(trimethylsilyl)amide), ethylaluminum bis(2,3,6,7-dibenzo-1-azacycloheptaneamide), n-octylaluminum bis(2,3,6,7-dibenzo-1-azacycloheptaneamide), n-octylaluminum bis(dimethyl(t-butyl)siloxide, ethylzinc (2,6-diphenylphenoxide), and ethylzinc (t-butoxide). These chain transfer agents are typically present in the reaction at a molar ratio of metal of the chain transfer agent to transition metal (from the amidinate catalyst compound) of 5:1 or more, preferably from 10:1 to 2000:1, preferably from 20:1 to 1000:1, preferably from 25:1 to 800:1, preferably from 50:1 to 700:1, preferably from 100:1 to 600:1.

### Activators

The terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include aluminum alkyls, ionizing activators, which may be neutral or ionic, and conventional-type cocatalysts. Preferred activators typically include ionizing anion precursor compounds that abstract a reactive, σ-bound, metal ligand making the metal complex cationic and providing a charge-balancing noncoordinating or weakly coordinating anion.

In a preferred embodiment, little or no alumoxane is used in the processes described herein. Preferably, alumoxane is present at zero mol %, alternately the alumoxane is present at a molar ratio of aluminum to transition metal less than 500:1, preferably less than 300:1, preferably less than 100:1, preferably less than 1:1.

The term “non-coordinating anion” or “NCA” (also referred to as a “non-coordinating anion activator,” or “NCAA”) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization.

It is within the scope of this invention to use an ionizing or stoichiometric activator, neutral or ionic, such as tri(n-butyl)ammonium tetrakis(pentafluorophenyl)borate, a tris perfluorophenyl boron metalloid precursor, or a tris perfluoronaphthyl boron metalloid precursor, polyhalogenated heteroborane anions (WO 98/43983), boric acid (U.S. Pat. No. 5,942,459), or combination thereof. It is also within the scope of this invention to use neutral or ionic activators alone or in combination with alumoxane or modified alumoxane activators.

Examples of neutral stoichiometric activators include tri-substituted boron, tellurium, aluminum, gallium, indium, or mixtures thereof. The three substituent groups are each independently selected from alkyls, alkenyls, halogens, substituted alkyls, aryls, arylhalides, alkoxy, and halides. Preferably, the three groups are independently selected from halogen, mono or multicyclic (including halosubstituted) aryls, alkyls, and alkenyl compounds, and mixtures thereof preferred are alkenyl groups having 1 to 20 carbon atoms, alkyl groups having 1 to 20 carbon atoms, alkoxy groups having 1 to 20 carbon atoms, and aryl groups having 3 to 20 carbon atoms (including substituted aryls). More preferably, the three groups are alkyls having 1 to 4 carbon groups, phenyl, naphthyl, or mixtures thereof. Even more preferably, the three groups are halogenated, preferably fluorinated, aryl groups. A preferred neutral stoichiometric activator is tris perfluorophenyl boron or tris perfluoronaphthyl boron.

Ionic stoichiometric activator compounds may contain an active proton, or some other cation associated with, but not coordinated to, or only loosely coordinated to, the remaining ion of the ionizing compound. Such compounds and the like are described in European Publications EP 0 570 982 A; EP 0 520 732 A; EP 0 495 375 A; EP 0 500 944 B1; EP 0 277 003 A; EP 0 277 004 A; U.S. Pat. Nos. 5,153,157; 5,198,401; 5,066,741; 5,206,197; 5,241,025; 5,384,299; 5,502,124; and U.S. patent application Ser. No. 08/285,380, filed Aug. 3, 1994; all of which are herein fully incorporated by reference.

Preferred compounds useful as an activator in the process of this invention comprise a cation, which is preferably a Bronsted acid capable of donating a proton, and a compatible non-coordinating anion which anion is relatively large (bulky), capable of stabilizing the active catalyst species (the Group 4 cation) which is formed when the two compounds are combined and said anion will be sufficiently labile to be displaced by olefinic, diolefinic, and acetylenically unsaturated substrates or other neutral Lewis bases, such as ethers, amines, and the like. Two classes of useful compatible non-coordinating anions have been disclosed in EP 0 277,003 A1, and EP 0 277,004 A1: 1) anionic coordination complexes comprising a plurality of lipophilic radicals covalently coordinated to and shielding a central charge-bearing metal or metalloid core; and 2) anions comprising a plurality of boron atoms such as carboranes, metallacarboranes, and boranes.

In a preferred embodiment, the stoichiometric activators include a cation and an anion component, and are preferably represented by the following formula (II):

(Z)_{d}⁺(A^{d-}) (II)

wherein Z is (L-H) or a reducible Lewis Acid; L is an neutral Lewis base; H is hydrogen; (L-H)⁺ is a Bronsted acid; A^{d-} is a non-coordinating anion having the charge d−; and d is an integer from 1 to 3.

When Z is (L-H) such that the cation component is (L-H)_{d}⁺, the cation component may include Bronsted acids such as protonated Lewis bases capable of protonating a moiety, such as an alkyl or aryl, from the bulky ligand metallocene containing transition metal catalyst precursor, resulting in a cationic transition metal species. Preferably, the activating cation (L-H)_{d}⁺ is a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxoniums from ethers, such as dimethyl ether diethyl ether, tetrahydrofuran, and dioxane, sulfoniums from thioethers, such as diethyl thioethers and tetrahydrothiophene, and mixtures thereof.

When Z is a reducible Lewis acid, it is preferably represented by the formula: (Ar₃C⁺), where Ar is aryl or aryl substituted with a heteroatom, a C₁ to C₄₀ hydrocarbyl, or a substituted C₁ to C₄₀ hydrocarbyl, preferably the reducible Lewis acid is represented by the formula: (Ph₃C⁺), where Ph is phenyl or phenyl substituted with a heteroatom, a C₁ to C₄₀ hydrocarbyl, or a substituted C₁ to C₄₀ hydrocarbyl. In a preferred embodiment, the reducible Lewis acid is triphenyl carbenium.

The anion component A^{d-} include those having the formula [M^{k+}Qₙ]^{d-} wherein k is 1, 2, or 3; n is 2, 3, 4, 5, or 6; n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than one occurrence is Q a halide, and two Q groups may form a ring structure. Preferably, each Q is a fluorinated hydrocarbyl group having 1 to 20 carbon atoms, more preferably each Q is a fluorinated aryl group, and most preferably each Q is a pentafluoryl aryl group. Examples of suitable A^{d-} components also include diboron compounds as disclosed in U.S. Pat. No. 5,447,895, which is fully incorporated herein by reference. Examples of suitable anion components also include so called expanded anions, preferably represented by the formula: (Z*J*ⱼ)^{-c}_{d}, wherein: Z* is an anion group of from 1 to 50 atoms, not counting hydrogen atoms, further containing two or more Lewis base sites, preferably selected from the group consisting of amide and substituted amide, amidinide and substituted amidinide, dicyanamide, imidazolide, substituted imidazolide, imidazolinide, substituted imidazolinide, tricycanomethide, tetracycanoborate, puride, 1,2,3-triazolide, substituted 1,2,3-triazolide, 1,2,4-triazolide, substituted 1,2,4-triazolide, pyrimidinide, substituted pyrimidinide, tetraimidazoylborate, and substituted tetraimidazoylborate anions, wherein each substituent, if present, is a C₁₋₂₀ hydrocarbyl, halohydrocarbyl, or halocarbyl group, or two such substituents together form a saturated or unsaturated ring system; each J* is, independently, a Lewis acid compound having from 3 to 100 atoms not counting hydrogen coordinated to at least one Lewis base site of Z*, and optionally two or more such J* groups may be joined together in a moiety having multiple Lewis acidic functionality; j is a number from 2 to 12; and c and d are integers from 1 to 3 (for further information and description of the expanded anions, please see U.S. Pat. No. 6,395,671, which is fully incorporated herein by reference).

In a preferred embodiment, this invention relates to a method to polymerize olefins comprising contacting olefins (preferably ethylene) with an amidinate catalyst compound, a chain transfer agent and a boron containing NCA activator represented by the formula (14):

Z_{d}⁺(A^{d-}) (14)

where: Z is (L-H) or a reducible Lewis acid; L is an neutral Lewis base (as further described above); H is hydrogen; (L-H) is a Bronsted acid (as further described above); A^{d-} is a boron containing non-coordinating anion having the charge d⁻ (as further described above); d is 1, 2, or 3.

In a preferred embodiment, in any NCA's represented by Formula 14 described above, the reducible Lewis acid is represented by the formula: (Ar₃C⁺), where Ar is aryl or aryl substituted with a heteroatom, a C₁ to C₄₀ hydrocarbyl, or a substituted C₁ to C₄₀ hydrocarbyl, preferably the reducible Lewis acid is represented by the formula: (Ph₃C⁺), where Ph is phenyl or phenyl substituted with a heteroatom, a C₁ to C₄₀ hydrocarbyl, or a substituted C₁ to C₄₀ hydrocarbyl.

In a preferred embodiment, in any of the NCA's represented by Formula 14 described above, Z_{d}⁺is represented by the formula: (L-H)_{d}⁺, wherein L is an neutral Lewis base; H is hydrogen; (L-H) is a Bronsted acid; and d is 1, 2, or 3, preferably (L-H)_{d}⁺ is a Bronsted acid selected from ammoniums, oxoniums, phosphoniums, silyliums, and mixtures thereof.

In a preferred embodiment, in any of the NCA's represented by Formula 14 described above, the anion component A^{d-} is represented by the formula [M*^{k*+}Q*_{n*}]^{d*-} wherein k* is 1, 2, or 3; n* is 1, 2, 3, 4, 5, or 6 (preferably 1, 2, 3, or 4); n*−k*=d*; M* is boron; and Q* is independently selected from hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q* having up to 20 carbon atoms with the proviso that in not more than one occurrence is Q* a halide.

This invention also relates to a method to polymerize olefins comprising contacting olefins (such as ethylene) with an amidinate catalyst compound, a chain transfer agent and an NCA activator represented by the formula (I):

RₙM**(ArNHa1)₄₋ₙ (I)

where R is a monoanionic ligand; M** is a Group 13 metal or metalloid; ArNHa1 is a halogenated, nitrogen-containing aromatic ring, polycyclic aromatic ring, or aromatic ring assembly in which two or more rings (or fused ring systems) are joined directly to one another or together; and n is 0, 1, 2, or 3. Typically the NCA comprising an anion of Formula I also comprises a suitable cation that is essentially non-interfering with the ionic catalyst complexes formed with the transition metal compounds, preferably the cation is Z_{d}⁺ as described above.

In a preferred embodiment in any of the NCA's comprising an anion represented by Formula I described above, R is selected from the group consisting of substituted or unsubstituted C₁ to C₃₀ hydrocarbyl aliphatic or aromatic groups, where substituted means that at least one hydrogen on a carbon atom is replaced with a hydrocarbyl, halide, halocarbyl, hydrocarbyl or halocarbyl substituted organometalloid, dialkylamido, alkoxy, aryloxy, alkysulfido, arylsulfido, alkylphosphido, arylphosphide, or other anionic substituent; fluoride; bulky alkoxides, where bulky means C₄ to C₂₀ hydrocarbyl groups; —SR¹, —NR²₂, and —PR³₂, where each R¹, R², or R³ is independently a substituted or unsubstituted hydrocarbyl as defined above; or a C₁ to C₃₀ hydrocarbyl substituted organometalloid.

In a preferred embodiment in any of the NCA's comprising an anion represented by Formula I described above, the NCA also comprises cation comprising a reducible Lewis acid represented by the formula: (Ar₃C⁺), where Ar is aryl or aryl substituted with a heteroatom, a C₁ to C₄₀ hydrocarbyl, or a substituted C₁ to C₄₀ hydrocarbyl, preferably the reducible Lewis acid represented by the formula: (Ph₃C⁺), where Ph is phenyl or phenyl substituted with a heteroatom, a C₁ to C₄₀ hydrocarbyl, or a substituted C₁ to C₄₀ hydrocarbyl.

In a preferred embodiment in any of the NCA's comprising an anion represented by Formula I described above, the NCA also comprises a cation represented by the formula, (L-H)_{d}⁺, wherein L is an neutral Lewis base; H is hydrogen; (L-H) is a Bronsted acid; and d is 1, 2, or 3, preferably (L-H)_{d}⁺ is a Bronsted acid selected from ammoniums, oxoniums, phosphoniums, silyliums, and mixtures thereof.

Further examples of useful activators include those disclosed in U.S. Pat. Nos. 7,297,653 and 7,799,879.

Another activator useful herein comprises a salt of a cationic oxidizing agent and a noncoordinating, compatible anion represented by the formula (16):

(OX^{e+})_{d}(A^{d-})ₑ (16)

wherein OX^{e+} is a cationic oxidizing agent having a charge of e+; e is 1, 2, or 3; d is 1, 2 or 3; and A^{d-} is a non-coordinating anion having the charge of d− (as further described above). Examples of cationic oxidizing agents include: ferrocenium, hydrocarbyl-substituted ferrocenium, Ag⁺, or Pb⁺². Preferred embodiments of A^{d-} include tetrakis(pentafluorophenyl)borate.

In another embodiment, the amidinate catalyst compounds and CTA's described herein can be used with Bulky activators. A “Bulky activator” as used herein refers to anionic activators represented by the formula:

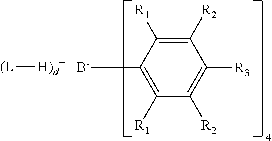

where:
each R₁ is, independently, a halide, preferably a fluoride;
each R₂ is, independently, a halide, a C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (preferably R₂ is a fluoride or a perfluorinated phenyl group);
each R₃ is a halide, C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (preferably R₃ is a fluoride or a C₆ perfluorinated aromatic hydrocarbyl group); wherein R₂ and R₃ can form one or more saturated or unsaturated, substituted or unsubstituted rings (preferably R₂ and R₃ form a perfluorinated phenyl ring);
L is an neutral Lewis base;
(L-H)⁺ is a Bronsted acid;
d is 1, 2, or 3;
wherein the anion has a molecular weight of greater than 1020 g/mol; and
wherein at least three of the substituents on the B atom each have a molecular volume of greater than 250 cubic Å, alternately greater than 300 cubic Å, or alternately greater than 500 cubic Å.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple ‘Back of the Envelope’ Method for Estimating the Densities and Molecular Volumes of Liquids and Solids,” Journal of Chemical Education, Vol. 71, No. 11, November 1994, pp. 962-964. Molecular volume (MV), in units of cubic Å, is calculated using the formula: MV=8.3Vₛ, where Vₛ is the scaled volume. Vₛ is the sum of the relative volumes of the constituent atoms, and is calculated from the molecular formula of the substituent using the following table of relative volumes. For fused rings, the Vₛ is decreased by 7.5% per fused ring.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary bulky substituents of activators suitable herein and their respective scaled volumes and molecular volumes are shown in the table below. The dashed bonds indicate binding to boron, as in the general formula above.

| | | Molecular | | | |
|---|---|---|---|---|---|
| | | Formula | | MV | Total |
| | | of each | | Per subst. | MV |
| Activator | Structure of boron substituents | substituent | Vₛ | (Å3) | (Å3) |
| Dimethylanilinium tetrakis(perfluoronaphthyl)borate | 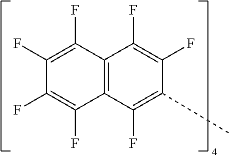 | C₁₀F₇ | 34 | 261 | 1044 |
| Dimethylanilinium tetrakis(perfluorobiphenyl)borate | 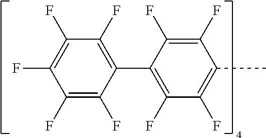 | C₁₂F₉ | 42 | 349 | 1396 |
| [4-tButyl-PhNMe₂H] [(C₆F₃(C₆F₅)₂)₄B] | 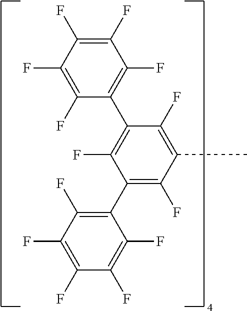 | C₁₈F₁₃ | 62 | 515 | 2060 |

Exemplary bulky activators useful in catalyst systems herein include: trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, [4-t-butyl-PhNMe₂H][(C₆F₃(C₆F₅)₂)₄B], and the types disclosed in U.S. Pat. No. 7,297,653.

Illustrative, but not limiting, examples of boron compounds which may be used as an activator in the processes of this invention are: trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, tropillium tetraphenylborate, triphenylcarbenium tetraphenylborate, triphenylphosphonium tetraphenylborate, triethylsilylium tetraphenylborate, benzene(diazonium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium)tetrakis(pentafluorophenyl)borate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluorophenyl)borate, dimethyl(t-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium)tetrakis-(2,3,4,6-tetrafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium)tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(t-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium)tetrakis(3,5-bis(trifluoromethyl)phenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, benzene(diazonium)tetrakis(3,5-bis(trifluoromethyl)phenyl)borate, and dialkyl ammonium salts, such as: di-(i-propyl)ammonium tetrakis(pentafluorophenyl)borate, and dicyclohexylammonium tetrakis(pentafluorophenyl)borate; and additional tri-substituted phosphonium salts, such as tri(o-tolyl)phosphonium tetrakis(pentafluorophenyl)borate, and tri(2,6-dimethylphenyl)phosphonium tetrakis(pentafluorophenyl)borate.

Preferred activators include N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Ph₃C⁺][B(C₆F₅)₄⁻], [Me₃NH⁺][B(C₆F₅)₄⁻]; 1-(4-(tris(pentafluorophenyl)borate)-2,3,5,6-tetrafluorophenyl)pyrrolidinium, tetrakis(pentafluorophenyl)borate, and 4-(tris(pentafluorophenyl)borate)-2,3,5,6-tetrafluoropyridine.

In a preferred embodiment, the activator comprises a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium)tetrakis(pentafluorophenyl)borate, trialkylammonium tetrakis-(2,3,4,6-tetrafluorophenyl)borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium)tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

In a preferred embodiment, any of the activators described herein may be mixed together before or after combination with the catalyst compound and/or CTA, preferably before being mixed with the catalyst compound and/or CTA.

In some embodiments, two NCA activators may be used in the polymerization and the molar ratio of the first NCA activator to the second NCA activator can be any ratio. In some embodiments, the molar ratio of the first NCA activator to the second NCA activator is 0.01:1 to 10,000:1, preferably 0.1:1 to 1000:1, preferably 1:1 to 100:1.

Further, the typical activator-to-catalyst ratio, e.g., all NCA activators-to-catalyst ratio is a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of this invention that the catalyst compounds can be combined with combinations of alumoxanes and NCA's (see, for example, U.S. Pat. Nos. 5,153,157; 5,453,410; EP 0 573 120 B1; WO 94/07928; and WO 95/14044 which discuss the use of an alumoxane in combination with an ionizing activator).

### Optional Scavengers

In addition to these activator compounds, scavengers may be used. Suitable compounds which may be utilized as scavengers include, for example, isobutylalumoxanes, such as IBAO-65, modified alumoxanes, such as MMAO 3A, and the like.

### Olefin Monomers

Any olefin may be used for the polymerization described herein. For example, an alpha olefin may be used. For the purposes of this invention and the claims thereto, the term “alpha olefin” refers to an olefin where the carbon-carbon double bond occurs between the alpha and beta carbons of the chain. Alpha olefins may be represented by the formula: H₂C═CH—R*, wherein each R* is independently, hydrogen or a C₁ to C₃₀ hydrocarbyl; preferably, methyl, ethyl, propyl, butyl, pentyl, heptyl, octyl, nonyl, decyl, undecyl, dodecyl, and substituted analogs thereof. For example, ethylene, propylene, butene, hexene, and octene are alpha olefins that are particularly useful in embodiments herein. The olefin may also be substituted at any position along the carbon chain with one or more substituents. Suitable substituents include, without limitation, alkyl, preferably, C₁₋₆ alkyl; cycloalkyl, preferably, C₃₋₆ cycloalkyl; as well as hydroxy, ether, keto, aldehyde, and halogen functionalities.

Preferred olefins include ethylene, propylene, butene, pentene, hexene, octene, nonene, decene, undecene, dodecene, and the isomers thereof.

In a particularly preferred embodiment, the olefin monomers comprise ethylene, preferably ethylene and a C₃ to C₁₂ comonomer (such as propylene, butene, pentene, heptene, octene, nonene, decene, undecene, dodecene, and mixtures thereof).

In a preferred embodiment, the olefin monomer is ethylene without comonomer, e.g., comonomer is present at 0 wt %.

### Polymerization

The reactants (including the olefins, the amidinate catalyst compounds, and the CTA's) are typically combined in a reaction vessel at a temperature of 20° C. to 200° C. (preferably 50° C. to 160° C., preferably 60° C. to 140° C.) and a pressure of 0 MPa to 1000 MPa (preferably 0.5 MPa to 500 MPa, preferably 1 MPa to 250 MPa) for a residence time of 0.5 seconds to 10 hours (preferably 1 second to 5 hours, preferably 1 minute to 1 hour). The molecular weight of the polymer products may be controlled by, inter alia, choice of catalyst, ratio of CTA to amidinate catalyst compound, and/or possibly temperature. In a preferred embodiment, the polymerization temperature is 50° C. or more, preferably 60° C. or more, preferably 70° C. or more, preferably 80° C. or more, and 250° C. or less, preferably 200° C. or less, preferably 175° C. or less, preferably 150° C. or less, preferably 130° C. or less, preferably 120° C. or less.

In certain embodiments, where the olefin is a gaseous olefin, the olefin pressure is typically greater than 5 psig (34.5 kPa); preferably, greater than 10 psig (68.9 kPa); and more preferably, greater than 45 psig (310 kPa). When a diluent is used with the gaseous olefin, the aforementioned pressure ranges may also be suitably employed as the total pressure of olefin and diluent. Likewise, when a liquid olefin is employed and the process is conducted under an inert gaseous atmosphere, then the aforementioned pressure ranges may be suitably employed for the inert gas pressure.

The quantity of catalyst that is employed in the process of this invention is any quantity that provides for an operable polymerization reaction. Preferably, the ratio of moles of olefin monomers to moles of amidinate catalyst compound is typically greater than 10:1; preferably greater than 100:1; preferably greater than 1000:1; preferably greater than 10,000:1; preferably greater than 25,000:1; preferably greater than 50,000:1; preferably greater than 100,000:1.

Typically, 0.00001 to 1.0 moles, preferably 0.0001 to 0.05 moles, preferably 0.0005 to 0.01 moles of catalyst are charged to the reactor per mole of olefin charged.

Typically, 0.00001 to 1.0 moles, preferably 0.0001 to 0.05 moles, preferably 0.0005 to 0.05 moles of amidinate catalyst compound are charged to the reactor per mole of CTA charged.

In some embodiments, alumoxanes are not present in the reaction. For examples in some embodiments, less than 0.5 mol %, preferably 0 mol % alumoxane is present in the reaction zone; alternately, the alumoxane is present at a molar ratio of aluminum to transition metal less than 500:1; preferably less than 300:1; preferably less than 100:1; preferably less than 1:1.

The polymerization process is typically a solution process, although it may be a bulk or high pressure process. Homogeneous processes are preferred. (A homogeneous process is defined to be a process where at least 90 wt % of the product is soluble in the reaction media.) A bulk homogeneous process is particularly preferred. (A bulk process is defined to be a process where reactant concentration in all feeds to the reactor is 70 volume % or more.) Alternately, no solvent or diluent is present or added in the reaction medium (except for the small amounts used as the carrier for the catalyst or other additives, or amounts typically found with the reactants, e.g., propane in propylene).

Suitable diluents/solvents for the process include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic; and alkylsubstituted aromatic compounds, such as benzene, toluene, mesitylene, and xylene. In a preferred embodiment, aliphatic hydrocarbon solvents are preferred, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic. Preferably, aromatics are present in the solvent at less than 1 wt %, preferably at 0.5 wt %, preferably at 0 wt % based upon the weight of the solvents. In another embodiment, suitable diluents/solvents also include aromatic hydrocarbons, such as toluene or xylenes, and chlorinated solvents, such as dichloromethane. In a preferred embodiment, the feed for the process comprises 60 vol % solvent or less, based on the total volume of the feed, preferably 40 vol % or less, preferably 20 vol % or less.

In another embodiment, the process is a slurry process. As used herein the term “slurry process” or “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

The process may be batch, semi-batch, or continuous. As used herein, the term continuous means a system that operates without interruption or cessation. For example, a continuous process to produce a polymer would be one where the reactants are continually introduced into one or more reactors and polymer product is continually withdrawn.

Useful reaction vessels include reactors (including continuous stirred tank reactors, batch reactors, reactive extruders, pipes, or pumps).

In a preferred embodiment, the productivity of the process is at least 200 g of polymer (preferably polymer represented by formula (X)) per mmol of catalyst per hour, preferably at least 5000 g/mmol/hour, preferably at least 10,000 g/mmol/hr, preferably at least 300,000 g/mmol/hr.

This invention further relates to a process, preferably an in-line process, preferably a continuous process, to produce polymer, comprising introducing olefin, CTA, activator, and amidinate catalyst compound into a reaction zone, obtaining a reactor effluent containing polymer, optionally removing (such as flashing off) solvent, unused monomer and/or other volatiles, obtaining polymer then functionalizing the polymer.

A “reaction zone” is defined as an area where activated catalysts and monomers are contacted and a polymerization reaction takes place. When multiple reactors are used in either series or parallel configuration, each reactor is considered as a separate reaction zone. For a multi-stage polymerization in both a batch reactor and a continuous reactor, each polymerization stage is considered as a separate reaction zone.

### Polymer

The processes described herein produce olefin homopolymers and copolymers (typically of one or more of ethylene (such as propylene, butene, pentene, hexene, octene, nonene, decene, undecene, and dodecene), preferably having an Mw of from 500 to 500,000 g/mol (alternately from 1000 to 450,000 g/mol, alternately from 1500 to 400,000 g/mol), and an Mw/Mn of from 1 to 1.5, preferably 1.1 to 1.4, preferably 1.1 to 1.3.

Preferably, the processes described herein produce olefin homopolymers and copolymers having an Mn (determined by GPC) of from A′ g/mol to Z g/mol, where A′ is (1/q×(yield of polyolefin in grams/mols of chain transfer agent+mols of transition metal catalyst compound)); and Z is (1/m×(yield of polyolefin in grams/mols of chain transfer agent+mols of transition metal catalyst compound)), where q is 0.5 and m is 4, alternately, q is 1 and m is 3.5, alternately q is 1.5 and m is 3, alternately q is 2 and m is 3. For example, in Run 5 of Table 2, yield of polymer was 0.047 g, the amount of aluminum compound was 1000×10⁻⁹ mols and the amount of transition metal catalyst compound was 20×10⁻⁹. Using 0.5 for q and 4 for m, A is calculated to be 92,156 and Z is calculated to be 11,519, thus, the Mn of the polymer produced in Run 5 should be between 92,156 and 11,519 g/mol.

Alternately, the processes described herein produce olefin homopolymers and copolymers (typically of one or more of ethylene (such as propylene, butene, pentene, hexene, octene, nonene, decene, undecene, and dodecene), preferably having an Mw of from 500 to 4,500,000 g/mol (alternately from 1000 to 2,000,000 g/mol, alternately from 1500 to 1,500,000 g/mol), and a multimodal molecular weight distribution, preferably a bimodal molecular weight distribution (as indicated by a multimodal or bimodal GPC trace, respectively).

In any embodiment described herein, the polymer produced (preferably an ethylene polymer) has a Tm of 100° C. or more, preferably 110° C. or more, preferably 115° C. or more, preferably 120° C. or more, preferably 125° C. or more, preferably 130° C. or more.

In a preferred embodiment of the invention, the polymer produced comprises at least 30 wt % (preferably at least 40 wt %, preferably at least 50 wt %, preferably at least 60 wt %, preferably at least 70 wt %, preferably at least 80 wt %, preferably at least 90 wt %, preferably at least 95 wt %, preferably at least 99 wt %, based upon the weight of the polymer) of ethylene.

In a preferred embodiment of the invention, the polymer produced herein comprises 90 to 100 wt % or more ethylene and 0 to 10 wt % comonomer (such as propylene, butene, pentene, hexene, octene, nonene, decene, undecene, dodecene, or a mixture thereof), preferably from 95 wt % to 99.9 wt % ethylene to 0.1 wt % to 5 wt % comonomer, preferably from 98 wt % to 99.0 wt % ethylene and 1 wt % to 2 wt % comonomer, based upon the weight of the polymer.

The polymers produced by the invention described herein also preferably have a metal group attached thereto such as aluminum or zinc and are referred to as end-metallated polyolefins. Prior to exposure to air or any other reactive molecules, the polymeric product will preferably comprise end-metallated polyolefin of the formula M(polyolefin)ₙ(R)_{y-n}, where M=the metal of the chain transfer agent(s), typically Al or Zn; n is 1, 2, or 3; y is 3 or 2, depending on the coordination number of the metal in the chain transfer agent; and R is hydrocarbyl radical, substituted hydrocarbyl (such as an alkyl, substituted alkyl, aryl or substituted aryl), preferably having 1 to 40 carbon atoms, preferably 1 to 20 carbon atoms, preferably 1 to 12 carbon atoms.

In a preferred embodiment, the polymer produced herein contains an aluminum group at the terminus of the polymer.

In a preferred embodiment, the process described herein produces a metallated polymer represented by the formula: M¹R²⁰₃ or M²R²⁰₂, preferably represented by the formula: AlR²⁰₃ or ZnR²⁰₂, where each R²⁰ is, independently, a polyolefin having an Mn of 50,000 g/mol or more (preferably 100,000 or more, preferably 150,000 or more, preferably 200,000 or more), M¹ is a group 13 atom (Al, B, or Ga), and M² is a group 12 atom (preferably Zn). In a preferred embodiment of the invention, each R²⁰ is, independently, a homopolymer or a copolymer comprising one of more of C₂ to C₂₀ olefins, preferably C₂ to C₂₀ alpha olefins, preferably C₂ to C₁₂ alpha olefins, preferably one or more of ethylene, propylene, butene, pentene, octene, heptene, octene, nonene, decene, undecene, dodecene, and isomers thereof. In a preferred embodiment of the invention, each R²⁰ is, independently, is an ethylene polymer, such as homopolyethylene or an ethylene copolymer comprising ethylene and from 0.1 mol % to 50 mol % comonomer (preferably from 0.1 mol % to 20 mol %, preferably from 0.5 mol % to 10 mol %, preferably from 1 mol % to 5 mol % comonomer), where the comonomer is preferably one of more of C₃ to C₂₀ olefins, preferably C₃ to C₂₀ alpha olefins, preferably C₃ to C₁₂ alpha olefins, preferably one or more of propylene, butene, pentene, octene, heptene, octene, nonene, decene, undecene, dodecene, and isomers thereof.

It is expected that the end-metallated polyolefins can be reacted with a broad range of molecules to produce new end-functionalized polyolefins. For example, trialkylaluminums are known to react with halides, such as iodine or bromine, to produce haloalkyls. Analogous chemistry with end-metallated polyolefins will produce end-halogenated polyolefins. Other electrophiles can also be reacted with end-metallated polyolefins to produce other derivatives. Reaction with carbon dioxide will form a carboxylate species that upon quenching with water will form an organic acid capped polyolefin. Reaction with isocyanates similarly would produce an amide-functionalized polyolefin. Other useful functionalization reactions include reaction with oxygen, ozone, or peroxides to form end-hydroxy functionalized polyolefins.

In a preferred embodiment, the metal-containing polyolefins are reacted with additional reactants (e.g., iodine, electrophiles, oxygen, peroxides, carbon dioxide, isocyanates, thioisocyanates, sulfur) to form polyolefin products containing a new functional group (e.g., carboxylic acid, hydroxy, amide) located at or near the end of the polyolefin chain.

The end-metallated polyolefins can be used to prepare block polyolefin products by growth of a second block using either coordinative polymerization (after chain transfer of the polymer chain to a suitable catalyst) or by the Aufbau process.

In a preferred embodiment, the metallated polymer produced herein is reacted with CO₂ to produce an acid, which may then be further functionalized.

In a preferred embodiment, the metallated polymer produced herein is reacted with a halogen, which may then be further functionalized.

Unless otherwise stated, for purposes of this invention and the claims hereto Mw, Mn, Mz, and Mw/Mn are determined according to GPC-SEC-DRI-LS method described in paragraphs [0600]-[0611] of U.S. Patent Application Publication No. 2008/0045638 at pages 37-38 including all references cited therein, except that dn/dc is 0.10 for all polymers.

Unless otherwise stated, for purposes of this invention and the claims hereto, Tm is determined by the DSC method described in the example section below.

In another embodiment, this invention relates to:

1. An amidinate catalyst compound is represented by the formula:

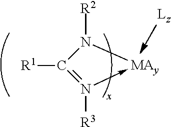

where M is a Group 4 metal, preferably Hf, Zr, or Ti;
R¹ is hydrogen, a hydrocarbyl group, a silylcarbyl group, a substituted silylcarbyl group, or a substituted hydrocarbyl group having 1 to 40 carbon atoms;
R² and R³ are each, independently, a hydrocarbyl group, a silylcarbyl group, a substituted silylcarbyl group, or a substituted hydrocarbyl group having 1 to 40 carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3; and
where x+y is equal to the coordination number of M, preferably 3 or 4, preferably 4.
2. The amidinate catalyst compound of paragraph 1, wherein:
R¹ is a substituted or unsubstituted tolyl or benzyl group having 7 to 40 carbon atoms, preferably is a substituted tolyl, benzyl (such as naphthyl);
R² and R³ are each, independently, a hydrocarbyl group, a silylcarbyl group, a substituted silylcarbyl group, or a substituted hydrocarbyl group having 1 to 40 carbon atoms (preferably 3 to 40 carbon atoms);
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3; and
where x+y is equal to the coordination number of M, preferably 3 or 4, preferably 4.
3. The amidinate catalyst of paragraph 1 or 2, wherein:
R² and R³ are, independently, selected from the group consisting of propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, benzyl, toluoyl, chlorophenyl, phenol, substituted phenol, CH₂C(CH₃)₃ 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
each L is, independently, tetrahydrofuran, dialkyl ether, dioxane, pyridine, pyrrole, or tertiary amines; and
each A is, independently, a hydrocarbyl radical, a halogen, a hydride, an amide, an alkoxide, a sulfide, an alkyl sulfonate, a phosphide, an amine, a phosphine, an ether or a combination thereof, or two A groups may be joined to form a dianionic group and may form a single ring of up to 30 non-hydrogen atoms or a multinuclear ring system of up to 30 non-hydrogen atoms.
4. The amidinate catalyst of paragraph 1, 2, 3, or 4, wherein M is Zr, Hf, or Ti, each A is methyl, chloride or benzyl, y is 4−x, and x is 1 or 2; preferably, when M is Zr, each A is methyl, y is 4−x, and x is 1 or 2; preferably, when M is Hf each A is methyl or benzyl, y is 4−x, and x is 1 or 2; and preferably, when M is Ti each A is benzyl, methyl or chloride, y is 4−x, and x is 1 or 2.
5. The amidinate catalyst of paragraph 1, 2, 3, or 4, wherein R¹ is selected from the group consisting of methyl, ethyl, propyl, isopropyl, butyl (including isobutyl, sec-butyl, tert-butyl and n-butyl), pentyl, cyclopentyl, hexyl, cyclohexyl, octyl, cyclooctyl, nonyl, decyl, cyclodecyl, dodecyl, cyclododecyl, mesityl, adamantyl, benzyl, toluoyl, chlorophenyl, phenol, substituted phenol, CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof.
6. The amidinate catalyst of paragraph 1, 2, 3, or 4, wherein R¹ is a substituted or unsubstituted tolyl or benzyl group having 7 to 40 carbon atoms and R² and R³ are each, independently, a hydrocarbyl group, a silylcarbyl group, a substituted silylcarbyl group, or a substituted hydrocarbyl group having 1 to 40 carbon atoms (preferably 3 to 40 carbon atoms).
7. The amidinate catalyst of paragraph 1, 2, 3, 4, or 6, wherein R¹ is a substituted tolyl or benzyl, such as naphthyl.
8. A method to polymerize olefins comprising:
1) contacting, at the transition temperature or higher (preferably at a temperature of 90° C. or more, typically 95° C. to 200° C., preferably 100° C. to 150° C.), olefins (preferably C₂ to C₄₀ olefins, preferably C₂ to C₂₀ alpha olefins, preferably ethylene, propylene, butene, pentene, hexene, heptene, octene, nonene, decene, undecene, dodecene, and isomers thereof) with the amidinate catalyst compound of paragraph 1, 2, 3, 4, or 5 above, a chain transfer agent, and a non-coordinating anion activator, where the molar ratio of the chain transfer agent(s) to amidinate catalyst compound(s) is 5:1 or more (alternately 10:1 or more, alternately 20:1 or more, alternately 50:1 or more, alternately 100:1 or more); and
2) obtaining polymer having an Mw (determined by GPC) of 500,000 g/mol or less (preferably 450,000 g/mol or less, preferably 400,000 g/mol or less), Mw/Mn of 1.5 or less (alternately 1.4 or less, alternately 1.3 or less), and an Mn (determined by GPC) of from A′ g/mol to Z g/mol, where A′ is (1/q×(yield of polyolefin in grams/mols of chain transfer agent+mols of transition metal catalyst compound)); and Z is (1/m×(yield of polyolefin in grams/mols of chain transfer agent+mols of transition metal catalyst compound)), where q is 0.5 and m is 4, alternately q is 1 and m is 3.5, alternately q is 1.5 and m is 3, alternately q is 2 and m is 3).
9. A method to obtain a polymer having a multimodal molecular weight distribution comprising contacting, at a temperature below the transition temperature, olefins (preferably C₂ to C₄₀ olefins, preferably C₂ to C₂₀ alpha olefins, preferably ethylene, propylene, butene, pentene, hexene, heptene, octene, nonene, decene, undecene, dodecene, and isomers thereof) with the amidinate catalyst compound of paragraph 1, 2, 3, 4, or 5 above, a chain transfer agent, and a non-coordinating anion activator, where the molar ratio of the chain transfer agent(s) to amidinate catalyst compound(s) is 5:1 or more (alternately 10:1 or more, alternately 20:1 or more, alternately 50:1 or more, alternately 100:1 or more); and 2) obtaining polymer having a multimodal GPC trace.
10. The method of paragraph 9, wherein 2 or more (alternately 3 or more, alternately 4 or more) chain transfer agents are present.
11. The method of paragraphs 9 or 10, wherein the polymer has a bimodal GPC trace.
12. The method of paragraph 8, 9, 10, or 11, wherein the polymer produced has a Tm of 100° C. or more.
13. The method of any of paragraphs 8 to 12, wherein the molar ratio of the chain transfer agent to amidinate catalyst compound(s) is 10:1 or more.
14. The method of any of paragraphs 8 to 13, wherein x+y=3 or 4.
15. The method of any of paragraphs 8 to 14, wherein the olefins comprise C₂ to C₄₀ olefins.
16. The method of any of paragraphs 8 to 15, wherein the olefins comprise one or more of ethylene, propylene, butene, pentene, hexene, heptene, octene, nonene, decene, undecene, dodecene, and isomers thereof
17. The method of paragraph 8, wherein the polymer has an Mw from 1000 to 450,000 g/mol and/or an Mw/Mn of from 1.1 to 1.4 and/or an Tm of 100° C. or more.
18. A metallated polymer represented by the formula M¹R²⁰₃, M²R²⁰₂, AlR²⁰₃, or ZnR²⁰₂, wherein each R²⁰ is, independently, a polyolefin having an Mn of 50,000 g/mol or more, M¹ is a group 13 atom, and M² is a group 12 atom.
19. The metallated polymer of paragraph 28, wherein each R²⁰ is, independently, a homopolymer or a copolymer comprising one of more of C₂ to C₂₀ olefins preferably an ethylene polymer comprising ethylene and from 0 to 50 mol % comonomer, preferably an ethylene copolymer comprising ethylene and from 0.1 to 20 mol % comonomer.

### EXAMPLES

### Tests and Materials

All molecular weights are reported in grams per mole unless otherwise noted.

NCA1 is N,N-dimethylanilinium tetrakis(pentafluorophenylborate).

NCA2 is triphenylcarbenium tetrakis(pentafluorophenylborate).

Catalyst 1 and Catalyst 2 are shown in Table 1, where Bn is benzyl.

Catalyst 3 is rac-dimethylsilylbis(indenyl)hafnium dimethyl.

Catalyst 4 is dimethylsilyl(tetramethylcyclopentadienyl)(cyclododecylamido)titanium dimethyl.

TABLE 1

| | |
|---|---|
| 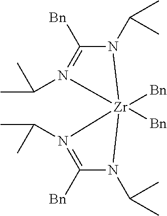 | Catalyst 1 |
| 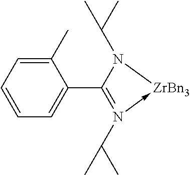 | Catalyst 2 |

### Example 1

### Preparation of Catalyst 1

Benzene (30 mL) was added to ZrBn₄ (2.49 g, 5.47 mmol) to form an orange solution. A benzene (4 mL) solution of 1,3-diisopropylcarbodiimide (1.38 g, 10.9 mmol) was added dropwise over 1 minute. The color lightened to a yellow-orange. After 1 hour the volatiles were evaporated with a stream of nitrogen at 45° C. to give a yellow-orange solid. This product was dried under reduced pressure. Yield: 3.79 g, 97.8%. ¹H NMR (CD₂Cl₂, 400 MHz): 7.34 (t, 2H), 7.25 (t, 1H), 7.17 (m, 6H), 6.81 (m, 1H), 3.78 (s, 2H), 3.60 (sept, 2H), 2.45 (br s, 2H), 1.02 (br s, 12H).

### Preparation of Catalyst 2

Step a: Et₂O (20 mL) and o-tolylmagnesium bromide (5 mL in Et₂O, 10 mmol) were combined and cooled to −25° C. 1,3-Diisopropylcarbodiimide (1.20 g, 9.50 mmol) was then added in one portion. The mixture was allowed to warm to ambient temperature and stirred for 1.5 hours. Water (40 mL) was added and the organics were separated, dried over MgSO₄, filtered, and evaporated to afford the amidine o-TolC(NiPr)NHiPr as a yellow oil (0.557 g, 26.9%). Step b: A benzene (2 mL) solution of o-TolC(NiPr)NHiPr (0.188 g, 0.861 mmol) was added dropwise to a benzene (5 mL) solution of ZrBn₄ (0.392 g, 0.861 mmol). The mixture was stirred overnight in the dark. The volatiles were removed under reduced pressure and the residue was extracted with hexane (8 mL). Filtration of the mixture followed by evaporation of the volatiles afforded the product as an orange oil that crystallized upon standing (0.458 g, 91.4%). ¹H NMR (C₆D₆, 250 MHz): 6.85-7.2 (aromatics, 19H), 3.08 (sept, 2H), 2.49 (s, 6H), 2.01 (s, 3H), 0.96 (d, 6H), 0.90 (d, 6H).

### POLYMERIZATION EXAMPLES

### General Polymerization Procedures

Ethylene/1-octene copolymerizations were carried out in a parallel, pressure reactor, as generally described in U.S. Pat. Nos. 6,306,658; 6,455,316; 6,489,168; WO 00/09255; and Murphy et al., J. Am. Chem. Soc., 2003, 125, pages 4306-4317, each of which is fully incorporated herein by reference to the extent not inconsistent with this specification. A pre-weighed glass vial insert and disposable stirring paddle were fitted to each reaction vessel of the reactor, which contains 48 individual reaction vessels. The reactor was then closed and each vessel was individually heated to a set temperature (usually between 50° C. and 110° C., see Table 2) and pressurized to a predetermined pressure of 1.38 MPa (200 psi) ethylene. 1-Octene (100 microliters, 637 micromol) was injected into each reaction vessel through a valve, followed by enough toluene to bring the total reaction volume, including the subsequent additions, to 5 mL. Tri-n-octylaluminum in toluene was then added, if used. The contents of the vessel were then stirred at 800 rpm. An activator solution (typically either 1.0-1.1 equiv of 0.40 mM dimethyl anilinium tetrakis-pentafluorophenyl borate (NCA1) in toluene was then injected into the reaction vessel along with 500 microliters toluene, followed by a toluene solution of catalyst (0.40 mM in toluene, between 20-80 nanomols of catalyst and another aliquot of toluene (500 microliters). Equivalence is determined based on the mol equivalents relative to the moles of the transition metal in the catalyst complex.

The reaction was then allowed to proceed until 20 psi (0.138 MPa) ethylene had been taken up by the reaction (ethylene pressure was maintained in each reaction vessel at the pre-set level by computer control). At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC (see below) to determine the molecular weight, by FT-IR (see below) to determine octene incorporation, and by DSC (see below) to determine melting point.

To determine various molecular weight related values by GPC, high temperature size exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388; each of which is fully incorporated herein by reference for US purposes. This apparatus has a series of three 30 cm×7.5 mm linear columns, each containing PLgel 10 um, Mix B. The GPC system was calibrated using polystyrene standards ranging from 580 g/mol-3,390,000 g/mol. The system was operated at an eluent flow rate of 2.0 mL/min and an oven temperature of 165° C. 1,2,4-trichlorobenzene was used as the eluent. The polymer samples were dissolved in 1,2,4-trichlorobenzene at a concentration of 0.1-0.9 mg/mL. 250 uL of a polymer solution was injected into the system. The concentration of the polymer in the eluent was monitored using an evaporative light scattering detector. The molecular weights presented in the examples are relative to linear polystyrene standards.

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./min and then cooled at a rate of 50° C./min. Melting points were collected during the heating period.

The amount of 1-octene to ethylene incorporated in the polymers (weight %) was determined by rapid FT-IR spectroscopy on a Bruker Equinox 55+IR in reflection mode. Samples were prepared in a thin film format by evaporative deposition techniques. Weight percent 1-octene was obtained from the ratio of peak heights at 1378 and 4322 cm⁻¹. This method was calibrated using a set of ethylene/1-octene copolymers with a range of known wt % 1-octene content.

### Example 2

The general polymerization process described above was used except that the temperature was kept at 95° C., and the amount of Oct₃Al was varied in each run. Shown in Table 2 as Runs 1-6 are data for the copolymerization of ethylene and 1-octene by a mixture of Catalysts 1 to 4 with 1.0 equivalent of NCA1. The general conditions were: Total volume=5 mL, solvent=isohexane, catalyst=20 nmol, activator=20 nmol, 1-octene=0.637 mmol. The data shows that Runs 5 and 6, which were performed at 105° C., produced very narrow molecular weight polymer, whereas Runs 1-4 run at 50° C. and 80° C. produced much higher molecular weight polymer of broader or bimodal Mw/Mn. Runs 7-10 and 11-14 show that catalysts 3 and 4, respectively do not undergo reversible chain transfer, as Mw does not decrease with increasing levels of AlOct₃.

TABLE 2
Ethylene 1-Octene Copolymerizations.

| | | | | | | | activity | | | | |
|---|---|---|---|---|---|---|---|---|---|---|---|
| | | | | | | | (g/mmol | wt % C₈ | | | |
| | catalyst/ | AlOct₃ | T | quench | yield | ethylene | catalyst/ | in | Mw | Mn | |
| run | activator | (nmol) | (° C.) | time(s) | (mg) | (psi) | h/bar) | product | (g/mol) | (g/mol) | Mw/Mn |
| 1* | 1/NCA1 | 1000 | 50 | 195 | 37 | 75 | 6633 | 2 | 1,763,524 | 872,072 | 2.0 |
| | | | | | | (517 kPa) | | | | | |
| 2* | 1/NCA1 | 1000 | 50 | 224 | 31 | 75 | 4835 | 3 | 2,667,940 | 1,762,248 | 1.5 |
| 3* | 1/NCA1 | 1000 | 80 | 358 | 40 | 75 | 3909 | 3 | 2,401,617 | 264,576 | bimodal |
| 4* | 1/NCA1 | 1000 | 80 | 284 | 33 | 75 | 3977 | 2 | 1,757,679 | 100,891 | bimodal |
| 5 | 1/NCA1 | 1000 | 105 | 169 | 47 | 200 | 3630 | 3 | 92,095 | 80,897 | 1.1 |
| | | | | | | (1379 kPa) | | | | | |
| 6 | 1/NCA1 | 1000 | 105 | 193 | 44 | 200 | 2948 | 4 | 88,389 | 77,333 | 1.1 |
| 7* | 3/NCA1 | 300 | 80 | 40 | 118 | 75 | 102015 | 34 | 303868 | 153564 | 1.98 |
| 8* | 3/NCA1 | 600 | 80 | 48 | 95 | 75 | 69472 | 35 | 341173 | 198948 | 1.71 |
| 9* | 3/NCA1 | 900 | 80 | 62 | 83 | 75 | 46657 | 27 | 411624 | 246787 | 1.67 |
| 10* | 3/NCA1 | 1200 | 80 | 59 | 81 | 75 | 47350 | 31 | 368210 | 220693 | 1.67 |
| 11* | 4/NCA1 | 300 | 80 | 72 | 126 | 75 | 60747 | 37 | 493527 | 252865 | 1.95 |
| 12* | 4/NCA1 | 600 | 80 | 75 | 115 | 75 | 53278 | 32 | 540241 | 287647 | 1.88 |
| 13* | 4/NCA1 | 900 | 80 | 65 | 105 | 75 | 56309 | 36 | 554020 | 318980 | 1.74 |
| 14* | 4/NCA1 | 1200 | 80 | 74 | 99 | 75 | 46272 | 38 | 548125 | 320758 | 1.71 |

*comparative

### Example 3

The polymerization process of Example 2 was repeated except that the temperature was kept at 95° C., 1-octene was omitted, and the amount of Oct₃Al was varied in each run. Shown in Table 3 are data for the polymerization of ethylene by a mixture of Catalyst 1 with 1.0 equivalent of NCA1. The general conditions were: Total volume=5 mL, solvent=isohexane, catalyst=20 nmol, activator=20 nmol, ethylene=200 psi (1379 kPa), AlOct₃=variable. Runs 1 and 16 contained 1000 nmol of dried MAO (defined to have an Mw of 58.06 g/mol) for use as a scavenger. Runs 1-8 show data for polymerizations performed at 95° C. Runs 9-15 show data for polymerizations performed at 105° C. Runs 16-23 show data for polymerizations run at 115° C. Data from Runs 2-15 and 17-23 show that very narrow molecular weight polymer can be obtained at all of these temperatures (i.e., 95° C., 105° C., or 115° C.) when there are 6 or more molar equivalents of AlOct₃ (relative to Catalyst 1) present in the reaction mixture. For comparison, Runs 1 and 16 did not contain any AlOct₃ and did not produce polymer having an Mw/Mn less than 1.5.

TABLE 3
Ethylene Homopolymerizations with Catalyst 1/Activator 1

| | | | | | activity | | | | | |
|---|---|---|---|---|---|---|---|---|---|---|
| | | | | | (g/mmol | | | | | |
| | catalyst/ | T | quench | yield | catalyst/ | Mw | Mn | Mw/ | Tₘ | Oct₃Al/Catalyst |
| run | activator | (° C.) | time(s) | (mg) | h/bar) | (g/mol) | (g/mol) | Mn | (° C.) | 1 molar ratio |
| 1* | 1/NCA1 | 95 | 229 | 48 | 2,731 | 2,758,815 | 1,645,526 | 1.7 | 137.6 | 0 |
| 2 | 1/NCA1 | 95 | 166 | 48 | 3,739 | 336,676 | 244,512 | 1.4 | 138.1 | 6.25 |
| 3 | 1/NCA1 | 95 | 144 | 49 | 4,424 | 140,792 | 106,351 | 1.3 | 137.4 | 12.5 |
| 4 | 1/NCA1 | 95 | 147 | 41 | 3,634 | 61,032 | 46,160 | 1.3 | 135.8 | 25 |
| 5 | 1/NCA1 | 95 | 162 | 44 | 3,567 | 63,215 | 47,865 | 1.3 | 135.9 | 50 |
| 6 | 1/NCA1 | 95 | 172 | 41 | 3,140 | 30,909 | 23,583 | 1.3 | 134.3 | 100 |
| 7 | 1/NCA1 | 95 | 829 | 46 | 718 | 15,659 | 10,582 | 1.5 | 131.6 | 200 |
| 8 | 1/NCA1 | 95 | 626 | 37 | 776 | 7,071 | 4,907 | 1.4 | 126.1 | 400 |
| 9 | 1/NCA1 | 105 | 220 | 40 | 2,355 | 232,508 | 162,188 | 1.4 | 137.4 | 6.25 |
| 10 | 1/NCA1 | 105 | 165 | 45 | 3,570 | 120,255 | 87,494 | 1.4 | 136.9 | 12.5 |
| 11 | 1/NCA1 | 105 | 182 | 45 | 3,231 | 61,594 | 43,948 | 1.4 | 136.8 | 25 |
| 12 | 1/NCA1 | 105 | 229 | 40 | 2,295 | 57,189 | 42,075 | 1.4 | 136.3 | 50 |
| 13 | 1/NCA1 | 105 | 1800 | 42 | 301 | 27,512 | 19,329 | 1.4 | 133.5 | 100 |
| 14 | 1/NCA1 | 105 | 1801 | 31 | 222 | 10,267 | 7,110 | 1.4 | 129.4 | 200 |
| 15 | 1/NCA1 | 105 | 1800 | 26 | 186 | 4,593 | 3,304 | 1.4 | 121.9 | 400 |
| 16* | 1/NCA1 | 115 | 1800 | 22 | 157 | 431,526 | 241,456 | 1.8 | 135.8 | 0 |
| 17 | 1/NCA1 | 115 | 1801 | 24 | 172 | 133,338 | 86,283 | 1.5 | 136.0 | 6.25 |
| 18 | 1/NCA1 | 115 | 413 | 40 | 1,253 | 100,846 | 66,421 | 1.5 | 136.5 | 12.5 |
| 19 | 1/NCA1 | 115 | 1801 | 36 | 262 | 45,804 | 29,984 | 1.5 | 134.8 | 25 |
| 20 | 1/NCA1 | 115 | 1800 | 28 | 201 | 36,431 | 24,380 | 1.5 | 134.1 | 50 |
| 21 | 1/NCA1 | 115 | 1800 | 23 | 168 | 16,079 | 10,471 | 1.5 | 131.3 | 100 |
| 22 | 1/NCA1 | 115 | 1800 | 27 | 199 | 7,107 | 4,735 | 1.5 | 125.1 | 200 |
| 23 | 1/NCA1 | 115 | 1802 | 18 | 130 | 3,310 | 2,522 | 1.3 | 116.5 | 400 |

*comparative

### Example 4

The polymerization process of Example 2 was repeated except that the temperature was kept at 95° C., and the amount of Oct₃Al was varied in each run. Shown in Table 4 are data for the copolymerization of ethylene and 1-octene by a mixture of Catalyst 1 with 1.0 molar equivalent of NCA1 at 95° C. The general conditions were: Total volume=5 mL, solvent=isohexane, catalyst=20 nmol, activator=20 nmol, ethylene=200 psi (1379 kPa), AlOct₃=variable, 1-octene=0.637 mmol Run 1 contained 1000 nmol of dried MAO for use as a scavenger. GPC-DRI data shown in Table 4 and were relative to polyethylene standards and were obtained using a GPC-DRI method similar to that disclosed in paragraphs [0600]-[0611] of U.S. Patent Application Publication No. 2008/0045638 at pages 37-38, including all references cited therein. Data from Runs 2-7 show that very narrow molecular weight distribution polymer can be obtained when there are 6 or more molar equivalents of AlOct₃ (relative to Catalyst 1) present in the reaction mixture. For comparison, Run 1 did not contain AlOct₃ and did not produce polymer of very narrow molecular weight distribution. Shown in FIG. 1 is a plot of (nanograms of polymer/Mn of polymer) vs. (nanomols of Catalyst 1 plus nanomols of AlOct₃) using data from Runs 2-7. The linear correlation indicates chain transfer from Catalyst 1 to aluminum and the slope of about 3 indicates that each aluminum contains 3 polymer chains.

TABLE 4
Ethylene 1-Octene Copolymerizations at 95° C.

| | | | | activity | | | | | |
|---|---|---|---|---|---|---|---|---|---|
| | catalyst/ | quench | yield | (g/mmol | Mw | Mn | Mw/ | Tm | AlOct₃/catalyst |
| run | activator | time(s) | (mg) | catalyst/h/bar) | (g/mol) | (g/mol) | Mn | (° C.) | 1 molar ratio |
| 1* | 1/NCA1 | 227 | 52 | 2,966 | 823,541 | 454,498 | 1.8 | 134.3 | 0 |
| 2 | 1/NCA1 | 167 | 41 | 3,197 | 136,610 | 103,987 | 1.3 | 136.7 | 6.25 |
| 3 | 1/NCA1 | 149 | 43 | 3,768 | 59,900 | 50,388 | 1.2 | 136.9 | 12.5 |
| 4 | 1/NCA1 | 151 | 46 | 3,941 | 28,817 | 24,442 | 1.2 | 135.8 | 25 |
| 5 | 1/NCA1 | 249 | 39 | 2,014 | 25,264 | 21,377 | 1.2 | 135.2 | 50 |
| 6 | 1/NCA1 | 145 | 43 | 3,855 | 14,596 | 11,804 | 1.2 | 133.3 | 100 |
| 7 | 1/NCA1 | 617 | 44 | 937 | 7,066 | 5,031 | 1.4 | 131.5 | 200 |

*comparative

### Example 5

The general polymerization process described above was used except that the temperature was 80° C. and the chain transfer agents were varied. Shown in Table 5 are data for the copolymerization of ethylene and 1-octene by a mixture of Catalyst 1 or Catalyst 2 with 1.0 equivalent of NCA1 or NCA2 at 80° C. The general conditions were: Total volume=5 mL, solvent=isohexane, catalyst=20 nmol, activator=20 nmol, 1-octene=0.637 mmol, ethylene pressure=75 psi (517 kPa), Temperature set point=80° C.

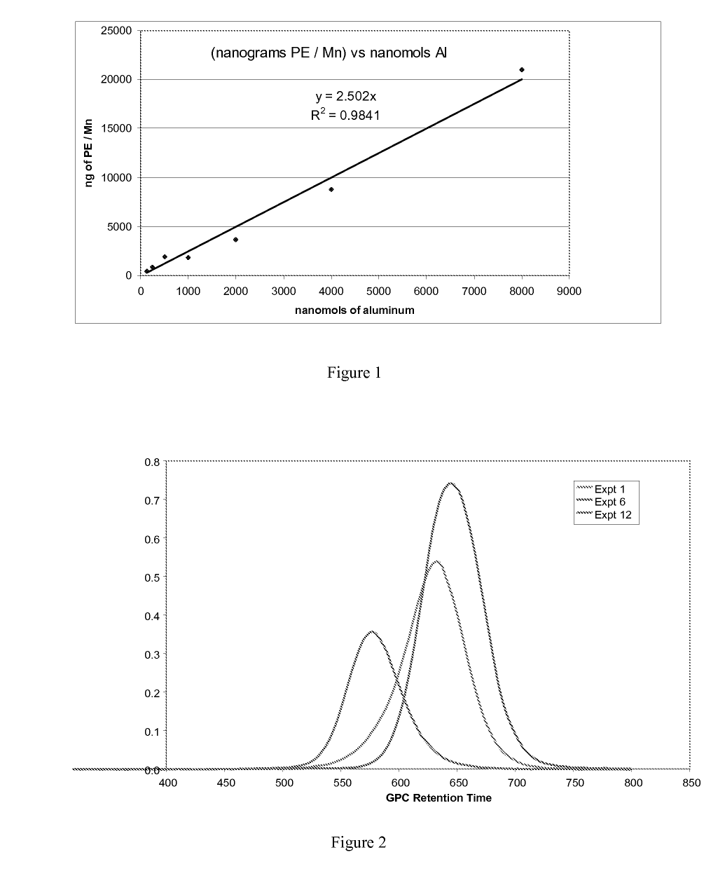

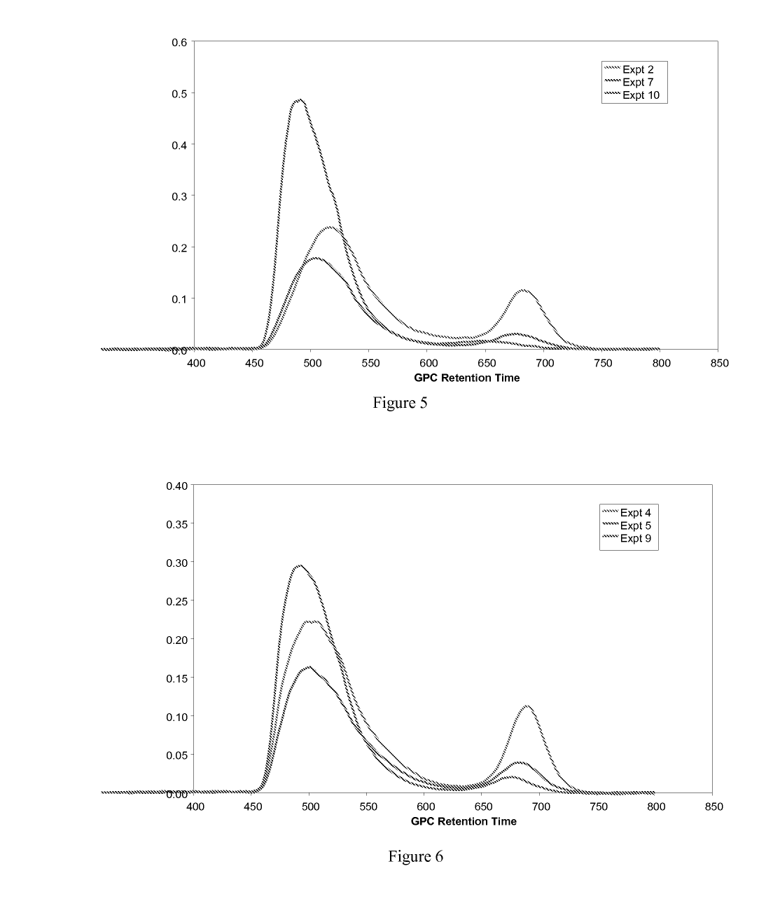

Data from Runs 1-12 shown that diethyl zinc can modulate the molecular weight distribution of both Catalysts 1 and 2. FIG. 2 shows that Catalyst 2/NCA1 in the absence of Et₂Zn, increasing the concentration of Oct₃Al decreases the molecular weight, and the polydispersity. However, in the presence of Et₂Zn and Oct₃Al, bimodal molecular weight distributions are obtained, as shown in FIG. 4. Increasing the concentration of Oct₃Al results in a decrease in average molecular weight, and a shift in the bimodal distribution of molecular weights. FIGS. 5 and 6 show that Catalyst 1/NCA1 exhibits similar behavior, with the exception that bimodal molecular weight distributions are observed in the presence and absence of Et₂Zn using this catalyst.

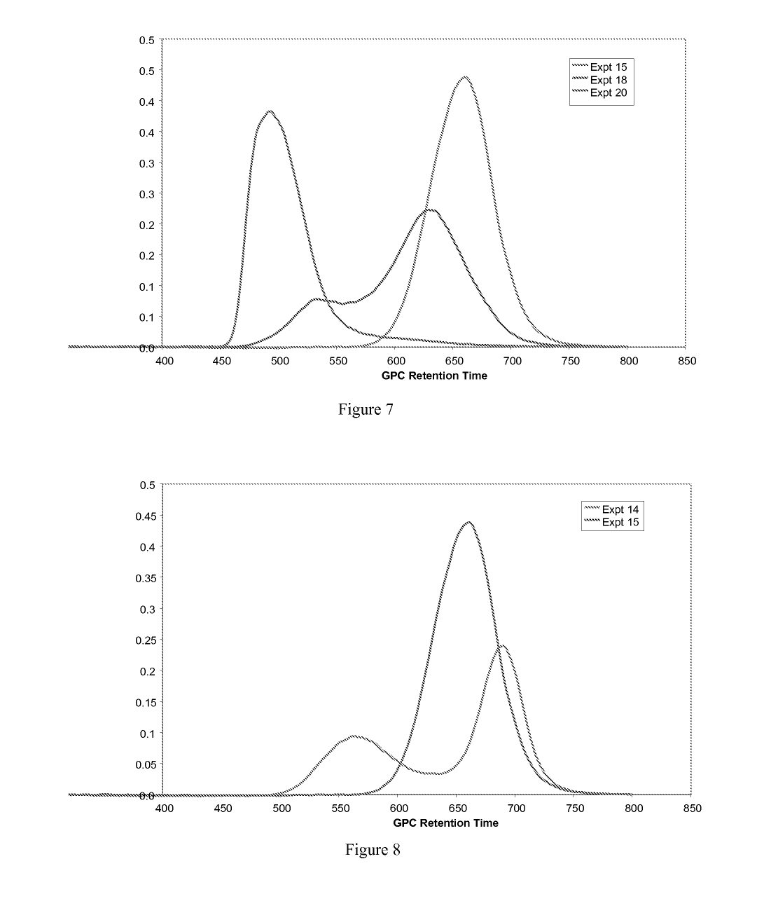

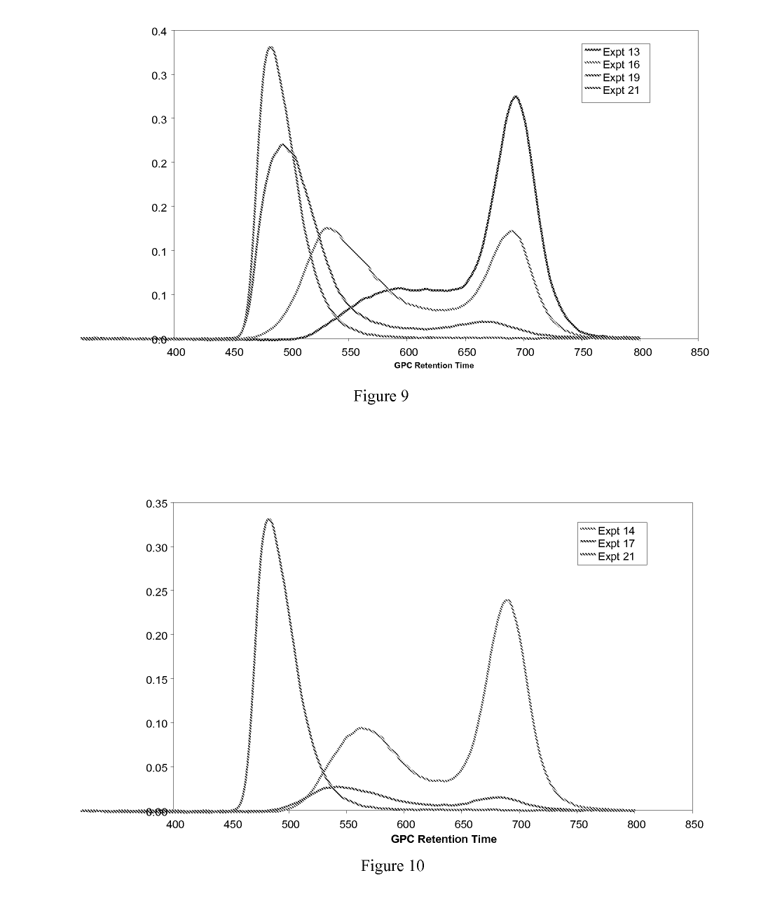

Data from Runs 13-21 (FIGS. 7-10) show that similar results are observed with NCA2.

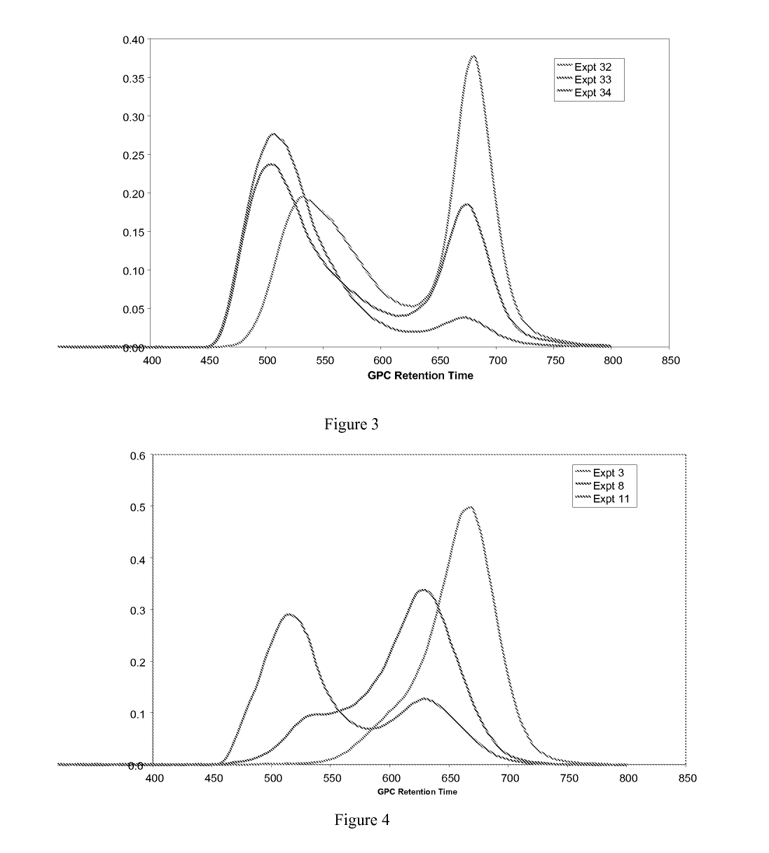

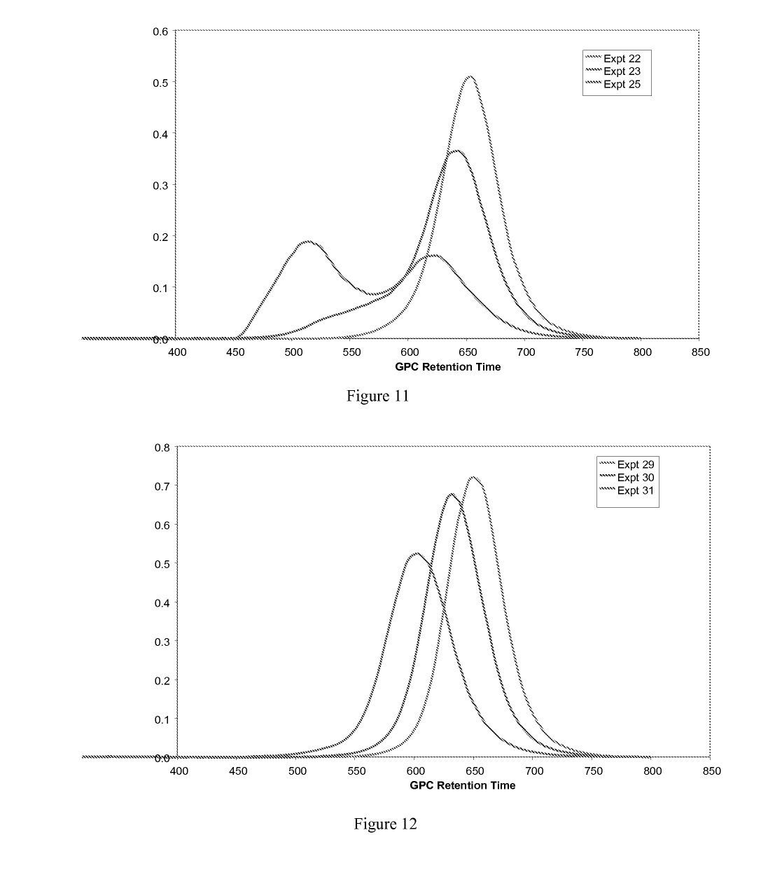

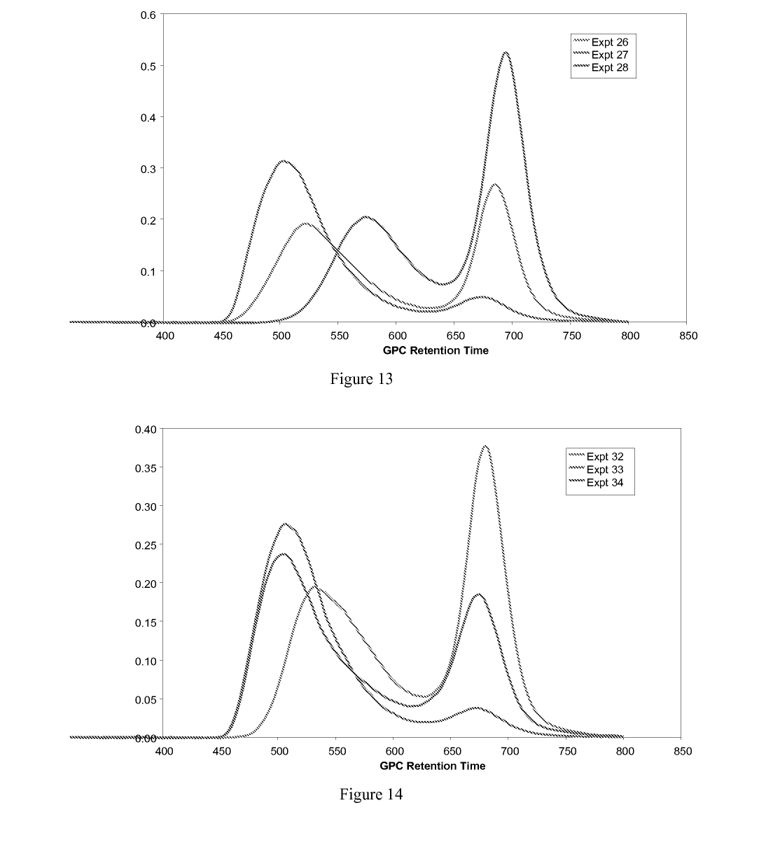

Data from Runs 22-34 (FIGS. 11-13) show that the identity of the chain transfer agent can affect the molecular weight distribution. FIGS. 11 and 12 compare the effect of Et₂Zn and iPr₂Zn, respectively, on Catalyst 2/NCA1. Et₂Zn (FIG. 11) shows bimodal molecular weight distributions at low Oct₃Al concentrations (as shown in FIG. 11), while iPr₂Zn does not modulate the effect of Oct₃Al on Catalyst 2/NCA1 (similar to FIG. 2, with no chain transfer agent). FIGS. 13 and 3 compare the effect of Et₂Zn and iPr₂Zn, respectively, on Catalyst 1/NCA1. With this catalyst system both Et₂Zn (FIG. 13) and iPr₂Zn (FIG. 14) show bimodal molecular weight distributions that are sensitive to Oct₃Al concentration.

TABLE 5
Ethylene 1-octene copolymerizations

| | | | | Chain | | | | | | | |
|---|---|---|---|---|---|---|---|---|---|---|---|
| | | | Chain | Transfer | | | Activity | | | | |
| | | Oct3Al | Transfer | Agent | Quench | Yield | (g/mmol | GPC Peak | Mw | Mn | |
| Exp | Catalyst | (μmol) | Agent | (μmol) | time(s) | (mg) | cat h) | number^{(a)} | (g/mol) | (g/mol) | Mw/Mn |
| 1 | 2/NCA1 | 1.20 | Et2Zn | 0.00 | 232 | 39 | 3018 | 1 | 84422 | 38667 | 2.18 |
| 2 | 1/NCA1 | 1.20 | Et2Zn | 0.00 | 331 | 35 | 1892 | 0 | 1454318 | 36475 | 39.87 |
| | | | | | | | | 1 | 2015804 | 995447 | 2.03 |
| | | | | | | | | 2 | 12590 | 9138 | 1.38 |
| 3 | 2/NCA1 | 1.20 | Et2Zn | 0.08 | 602 | 18 | 532 | 1 | 44198 | 15418 | 2.87 |
| 4 | 1/NCA1 | 1.20 | Et2Zn | 0.08 | 458 | 37 | 1446 | 0 | 1984122 | 35499 | 55.89 |
| | | | | | | | | 1 | 2576570 | 1121579 | 2.30 |
| 5 | 1/NCA1 | 0.75 | Et2Zn | 0.08 | 279 | 39 | 2532 | 0 | 2179950 | 65072 | 33.50 |
| | | | | | | | | 1 | 2583265 | 1170074 | 2.21 |
| 6 | 2/NCA1 | 0.75 | Et2Zn | 0.00 | 602 | 14 | 410 | 0 | 43362 | 23323 | 1.86 |
| 7 | 1/NCA1 | 0.75 | Et2Zn | 0.00 | 327 | 36 | 1977 | 0 | 2209477 | 86018 | 25.69 |
| | | | | | | | | 1 | 2563611 | 1351276 | 1.90 |
| 8 | 2/NCA1 | 0.75 | Et2Zn | 0.08 | 602 | 30 | 882 | 0 | 316128 | 45185 | 7.00 |
| | | | | | | | | 1 | 114274 | 41209 | 2.77 |
| 9 | 1/NCA1 | 0.30 | Et2Zn | 0.08 | 601 | 31 | 919 | 0 | 2924511 | 216875 | 13.48 |
| | | | | | | | | 1 | 3102162 | 1661483 | 1.87 |
| 10 | 1/NCA1 | 0.30 | Et2Zn | 0.00 | 346 | 40 | 2104 | 0 | 3113617 | 385673 | 8.07 |
| | | | | | | | | 1 | 3269436 | 1841052 | 1.78 |
| 11 | 2/NCA1 | 0.30 | Et2Zn | 0.08 | 602 | 19 | 574 | 0 | 1474699 | 95832 | 15.39 |
| | | | | | | | | 1 | 2173833 | 1179588 | 1.84 |
| | | | | | | | | 2 | 61217 | 34005 | 1.80 |
| 12 | 2/NCA1 | 0.30 | Et2Zn | 0.00 | 136 | 39 | 5160 | 1 | 319713 | 184687 | 1.73 |
| 13 | 1/NCA2 | 1.20 | | 0.00 | 600 | 15 | 456 | 0 | 88154 | 8895 | 9.91 |
| | | | | | | | | 1 | 9872 | 6690 | 1.48 |
| | | | | | | | | 2 | 277437 | 113082 | 2.45 |
| 14 | 1/NCA2 | 0.75 | Et2Zn | 0.08 | 602 | 12 | 368 | 0 | 188659 | 11409 | 16.54 |
| | | | | | | | | 1 | 10765 | 7400 | 1.45 |
| | | | | | | | | 2 | 516234 | 293821 | 1.76 |
| 15 | 2/NCA2 | 0.75 | | 0.00 | 602 | 12 | 365 | 1 | 31242 | 16033 | 1.95 |
| 16 | 1/NCA2 | 0.75 | | 0.00 | 600 | 17 | 504 | 0 | 600420 | 18481 | 32.49 |
| | | | | | | | | 1 | 1093713 | 557592 | 1.96 |
| | | | | | | | | 2 | 11339 | 7819 | 1.45 |
| 17 | 1/NCA2 | 0.30 | Et2Zn | 0.08 | 600 | 11 | 336 | 0 | 563464 | 27632 | 20.39 |
| 18 | 2/NCA2 | 0.30 | | 0.00 | 602 | 13 | 379 | 0 | 331729 | 38560 | 8.60 |
| | | | | | | | | 1 | 83107 | 34153 | 2.43 |
| 19 | 1/NCA2 | 0.30 | | 0.00 | 602 | 31 | 924 | 0 | 2859146 | 113488 | 25.19 |
| | | | | | | | | 1 | 3298379 | 1988470 | 1.66 |
| 20^{(b)} | 2/NCA2 | 0.00 | | 0.00 | 289 | 40 | 1235 | 1 | 3354498 | 2096622 | 1.60 |
| 21^{(b)} | 1/NCA2 | 0.00 | | 0.00 | 221 | 36 | 1464 | 1 | 4195676 | 3100999 | 1.35 |
| 22 | 2/NCA1 | 1.20 | Et2Zn | 0.08 | 229 | 37 | 2872 | 1 | 38094 | 17955 | 2.12 |
| 23 | 2/NCA1 | 0.75 | Et2Zn | 0.08 | 254 | 39 | 2740 | 0 | 172136 | 25553 | 6.74 |
| 24 | 2/NCA1 | 0.75 | Et2Zn | 0.08 | | | | 1 | 67946 | 25925 | 2.62 |
| 25 | 2/NCA1 | 0.30 | Et2Zn | 0.08 | 602 | 35 | 1047 | 0 | 1246150 | 61253 | 20.34 |
| | | | | | | | | 1 | 2405834 | 1340804 | 1.79 |
| | | | | | | | | 2 | 84360 | 39726 | 2.12 |
| 26 | 1/NCA1 | 1.20 | Et2Zn | 0.08 | 497 | 35 | 1268 | 0 | 856675 | 15975 | 53.63 |
| | | | | | | | | 1 | 11407 | 8017 | 1.42 |
| | | | | | | | | 2 | 1560050 | 621240 | 2.51 |
| 27 | 1/NCA1 | 0.30 | Et2Zn | 0.08 | 372 | 34 | 1621 | 0 | 2227724 | 86338 | 25.80 |
| | | | | | | | | 1 | 2555786 | 1063420 | 2.40 |
| 28 | 1/NCA1 | 0.75 | Et2Zn | 0.08 | 601.1 | 13 | 392 | 0 | 149530 | 9192 | 16.27 |
| | | | | | | | | 1 | 9077 | 6093 | 1.49 |
| | | | | | | | | 2 | 373592 | 177245 | 2.11 |
| 29 | 2/NCA1 | 1.20 | iPr2Zn | 0.08 | 190.9 | 37 | 3460 | 1 | 36435 | 18919 | 1.93 |
| 30 | 2/NCA1 | 0.75 | iPr2Zn | 0.08 | 134.9 | 40 | 5284 | 1 | 64481 | 31137 | 2.07 |
| 31 | 2/NCA1 | 0.30 | iPr2Zn | 0.08 | 138.6 | 38 | 4961 | 1 | 179191 | 71854 | 2.49 |
| 32 | 1/NCA1 | 1.20 | iPr2Zn | 0.08 | 263.0 | 37 | 2546 | 0 | 466629 | 15836 | 29.47 |
| | | | | | | | | 1 | 14093 | 9519 | 1.48 |
| | | | | | | | | 2 | 975327 | 407687 | 2.39 |
| 33 | 1/NCA1 | 0.30 | iPr2Zn | 0.08 | 282.4 | 34 | 2167 | 0 | 2031916 | 92222 | 22.03 |
| | | | | | | | | 1 | 2301593 | 930218 | 2.47 |
| 34 | 1/NCA1 | 0.75 | iPr2Zn | 0.08 | 282.5 | 33 | 2096 | 0 | 1439674 | 24402 | 59.00 |
| | | | | | | | | 1 | 2316019 | 905768 | 2.56 |
| | 2/NCA1 | | | | | 39 | | 2 | 18032 | 11250 | 1.60 |

^{(a)}GPC Peak Number: 0: Calculation of entire distribution of peaks, 1: Calculation of individual lower Mw peak, 2: Calculation of individual higher Mw peaks. Calculations, including deconvolutions to obtain individual lower MW peaks and individual higher Mw peaks made using Epoch ™ Version 4.0.3.10 software.
^{(b)}40 nmol catalyst, 40 nmol activator

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Further whenever a composition, an element or a group of elements is preceded with the transitional phrase “comprising”, it is understood that we also contemplate the same composition or group of elements with transitional phrases “consisting essentially of,” “consisting of”, “selected from the group consisting of,” or “is” preceding the recitation of the composition, element, or elements and vice versa.

What is claimed is:

1. A method to polymerize olefins comprising contacting, at the transition temperature or higher, olefins with an amidinate catalyst compound, a chain transfer agent and a non-coordinating anion activator where the molar ratio of the chain transfer agent(s) to amidinate catalyst compound(s) is 5:1 or more, and where the amidinate catalyst compound is represented by the formula: 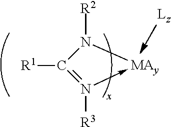
where M is a Group 4 metal;
R¹ is hydrogen, a hydrocarbyl group, a silylcarbyl group, a substituted silylcarbyl group, or a substituted hydrocarbyl group having 1 to 40 carbon atoms;
R² and R³ are each, independently, a hydrocarbyl group, a silylcarbyl group, a substituted silylcarbyl group, or a substituted hydrocarbyl group having 1 to 40 carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3;
where x+y is equal to the coordination number of M; and
obtaining polymer having an Mw (determined by GPC-DRI) of 500,000 g/mol or less, Mw/Mn of 1.5 or less, and an Mn (determined by GPC-DRI) of from A′ g/mol to Z g/mol, where A′ is (1/q×(yield of polyolefin in grams/mols of chain transfer agent+mols of transition metal catalyst compound)); and Z is (1/m×(yield of polyolefin in grams/mols of chain transfer agent+mols of transition metal catalyst compound)), where q is 0.5 and m is 4.

2. The method of claim 1, wherein M is Zr of Hf.

3. The method of claim 1, wherein the molar ratio of the chain transfer agent(s) to amidinate catalyst compound(s) is 10:1 or more.

4. The method of claim 1, where x+y=3 or 4.

5. The method of claim 1, wherein the olefins comprise C₂ to C₄₀ olefins.

6. The method of claim 1, wherein the olefins comprise one or more of ethylene, propylene, butene, pentene, hexene, heptene, octene, nonene, decene, undecene, dodecene, and isomers thereof.

7. The method of claim 1, wherein the temperature is 95° C. to 200° C.

8. The method of claim 1 where:
R¹ is selected from the group consisting of methyl, ethyl, propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, toluoyl, chlorophenyl, phenol, substituted phenol, or CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl and substituted analogs and isomers thereof;
R² and R³ are, independently, selected from the group consisting of methyl, ethyl, propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, toluoyl, chlorophenyl, phenol, substituted phenol, or CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
each L is, independently, tetrahydrofuran, dialkyl ether, dioxane, pyridine, pyrrole, or tertiary amines;
each A is, independently, a hydrocarbyl radical, a halogen, a hydride, an amide, an alkoxide, a sulfide, an alkyl sulfonate, a phosphide, an amine, a phosphine, an ether, or a combination thereof, or two A groups may be joined to form a dianionic group and may form a single ring of up to 30 non-hydrogen atoms or a multinuclear ring system of up to 30 non-hydrogen atoms.

9. The method of claim 1, wherein R¹ is a substituted or unsubstituted tolyl or benzyl group having 7 to 40 carbon atoms.

10. The method of claim 9, wherein R² and R³ are each, independently, a hydrocarbyl group, a silylcarbyl group, a substituted silylcarbyl group, or a substituted hydrocarbyl group having 3 to 40 carbon atoms.

11. The method of claim 1, wherein M is Zr, Hf, or Ti; each A is methyl, chloride, or benzyl; y is 4−x; and x is 1 or 2.

12. The method of claim 1, wherein M is Zr; each A is methyl; y is 4−x; and x is 1 or 2.

13. The method of claim 1, wherein M is Hf; each A is methyl or benzyl; y is 4−x; and x is 1 or 2.

14. The method of claim 1, wherein M is Ti; each A is benzyl, methyl, or chloride; y is 4−x; and x is 1 or 2.

15. The method of claim 1, wherein the polymer has an Mw from 1000 to 450,000 g/mol and/or an Mw/Mn of from 1.1 to 1.4.

16. The method of claim 1, wherein the polymer produced herein has a Tm of 100° C. or more.

17. A method to obtain a polymer having a multimodal molecular weight distribution comprising contacting olefins, at a temperature less than the transition temperature, with an amidinate catalyst compound, a chain transfer agent, and a non-coordinating anion activator, where the molar ratio of the chain transfer agent(s) to amidinate catalyst compound(s) is 5:1 or more, and where the amidinate catalyst compound is represented by the formula: 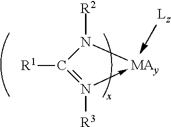
where M is a Group 4 metal;
R¹ is hydrogen, a hydrocarbyl group, a silylcarbyl group, a substituted silylcarbyl group, or a substituted hydrocarbyl group having 1 to 40 carbon atoms;
R² and R³ are each, independently, a hydrocarbyl group, a silylcarbyl group, a substituted silylcarbyl group, or a substituted hydrocarbyl group having 1 to 40 carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3;
where x+y is equal to the coordination number of M; and
obtaining polymer having a multimodal GPC trace.

18. The method of claim 17, wherein R¹ is a substituted or unsubstituted tolyl or benzyl group having 7 to 40 carbon atoms.

19. The method of claim 18, wherein R² and R³ are each, independently, a hydrocarbyl group, a silylcarbyl group, a substituted silylcarbyl group, or a substituted hydrocarbyl group having 3 to 40 carbon atoms.

20. The method of claim 17, wherein two or more chain transfer agents are present.

21. The method of claim 17, wherein the olefins comprise C₂ to C₄₀ olefins.

22. The method of claim 17, wherein the olefins comprise one or more of ethylene, propylene, butene, pentene, hexene, heptene, octene, nonene, decene, undecene, dodecene, and isomers thereof.

23. The method of claim 17, wherein the temperature is less than 90° C.

24. The method of claim 17, wherein M is Zr, Hf, or Ti; each A is methyl, chloride, or benzyl; y is 4−x; and x is 1 or 2.

25. An amidinate catalyst compound represented by the formula: 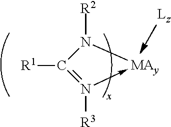
where M is a Group 4 metal;
R¹ is a substituted or unsubstituted tolyl or benzyl group having 7 to 40 carbon atoms;
R² and R³ are each, independently, a hydrocarbyl group, a silylcarbyl group, a substituted silylcarbyl group, or a substituted hydrocarbyl group having 1 to 40 carbon atoms;
each L is, independently, a Lewis base, provided that each L is not a cyclopentadienyl group;
each A is, independently, any anionic ligand, provided that each A is not a cyclopentadienyl group;
x is 1, 2, or 3;
y is 0, 1, 2, or 3;
z is 0, 1, 2, or 3; and
where x+y is equal to the coordination number of M.

26. The amidinate of claim 25, wherein R¹ is a substituted tolyl or benzyl group.

27. The amidinate of claim 25, wherein:
R² and R³ are, independently, selected from the group consisting of propyl, isopropyl, butyl (including isobutyl, sec-butyl, tert-butyl, and n-butyl), pentyl, cyclopentyl, hexyl, cyclohexyl, octyl, cyclooctyl, nonyl, decyl, cyclodecyl, dodecyl, cyclododecyl, mesityl, adamantyl, phenyl, benzyl, toluoyl, chlorophenyl, phenol, substituted phenol, or CH₂C(CH₃)₃, 2,6-diethylphenyl, 2,6-diisopropylphenyl, 2-isopropylphenyl, 2-ethyl-6-methylphenyl, 3,5-ditertbutylphenyl, 2-tertbutylphenyl, 2,3,4,5,6-pentamethylphenyl, and substituted analogs and isomers thereof;
each L is, independently, tetrahydrofuran, dialkyl ether, dioxane, pyridine, pyrrole, or tertiary amines; and
each A is, independently, a hydrocarbyl radical, a halogen, a hydride, an amide, an alkoxide, a sulfide, an alkyl sulfonate, a phosphide, an amine, a phosphine, an ether, or a combination thereof, or two A groups may be joined to form a dianionic group and may form a single ring of up to 30 non-hydrogen atoms or a multinuclear ring system of up to 30 non-hydrogen atoms.

28. A metallated polymer represented by the formula M¹R²⁰₃ or M²R²⁰₂, wherein each R²⁰ is, independently, a polyolefin having an Mn of 50,000 g/mol or more, M¹ is a group 13 atom, and M² is a group 12 atom.

29. A metallated polymer represented by the formula AlR²⁰₃ or ZnR²⁰₂, wherein each R²⁰ is, independently, a polyolefin having an Mn of 50,000 g/mol or more.

30. The metallated polymer of claim 28, wherein each R²⁰ is, independently, a homopolymer or a copolymer comprising one of more of C₂ to C₂₀ olefins.

31. The metallated polymer of claim 29, wherein each R²⁰ is, independently, an ethylene polymer comprising ethylene and from 0 mol % to 50 mol % comonomer.

32. The metallated polymer of claim 29, wherein each R²⁰ is, independently, an ethylene copolymer comprising ethylene and from 0.1 mol % to 20 mol % comonomer.
